(19) United States
(12) Patent Application Publication
(10) Pub. No.: US 2007/0189934 A1
(43) Pub. Date: Aug. 16, 2007

(54) AUTOMATED SOLID PHASE SYNTHESIS SYSTEMS AND METHODS

(76) Inventors: Barry King, Boulder, CO (US); Eric Hoart, Idaho Falls, ID (US)

Correspondence Address: ROCHE COLORADO CORPORATION;ATTN: Legal Department, Boulder Technology Center, 2075 North 55th Street, Boulder, CO, 80301, US

(21) Appl. No.: 11/567,456

(22) Filed: Dec. 6, 2006

Related U.S. Application Data
(60) Provisional application No. 60/748,113, filed on Dec. 6, 2005.

(51) Int. Cl. B01L 1/02

(52) U.S. Cl. 422/105; 530/333

(57) ABSTRACT

A solid phase synthesis system including one or more reaction vessels, one or more structural unit chemical dispensing units, one or more synthesis chemical dispensing units, and a controller is provided. The arrangement of the reaction vessels, dispensing units and corresponding fluid interconnections restricts cross-contamination within the system. The controller facilitates automated or semi-automated production of various organic compounds. Associated software including varying command structures may be provided to facilitate ease in programming and automating of the synthesis system.

### CROSS-REFERENCE TO RELATED APPLICATIONS

This application claims priority to U.S. Provisional Patent Application Ser. No. 60/748,113 filed on Dec. 6, 2005, and entitled “AUTOMATED SOLID PHASE SYNTHESIS SYSTEMS AND METHODS”, which is incorporated herein by reference in its entirety.

### FIELD OF THE INVENTION

The present invention relates generally to the synthesis of organic compounds using sequential solid phase chemistry synthesis. More particularly, the present invention relates to an automatable system for use in the synthesis of various organic compounds using solid phase chemical synthesis techniques and methods relating thereto.

### BACKGROUND OF THE INVENTION

There are many instances where it is desirable to synthesize an organic compound of a desired structure. For example, it is often desirable to synthesize peptides, polynucleotides, polysaccharides and other organic compounds in a specific sequence. However, synthesizing such organic compounds in a specific sequence can be troublesome due to the reactivity of various portions of the reactants used in the synthesis. With respect specifically to peptides, it may be difficult to synthesize peptides of a desired sequence due to the reactivity of the amino acid functional groups and terminal ends.

One approach to synthesizing peptides and other organic compounds is solid phase chemical synthesis (“solid phase synthesis”). In this approach, one end of a structural unit chemical (e.g., an amino acid) is bound to a solid phase support (e.g., an insoluble resin). The non-bonded end may be bonded to another structural unit chemical, with various intervening rinses and deprotection steps, to create an organic compound. These processes may be repeated as desired until an organic compound of a desired structure is produced.

For example, to create a peptide using solid phase synthesis, the carboxyl terminus of an amino acid may be covalently bonded to an insoluble solid support, such as a resin, while the amine terminus of the amino acid is left “unprotected” to react with an incoming amino acid. The incoming amino acid generally includes a “protecting” agent bonded to the amine terminus and/or functional group to restrict the amine terminus and/or functional group from reacting with the bonded amino acid. Thus, the carboxyl terminus of the incoming amino acid may react with the amine terminus of the supported amino acid to form the desired peptide. After reaction, the amine terminus of the peptide is deprotected with a deprotection agent so that it may react with the carboxyl terminus of a second incoming amino acid. A solvent may be used to wash away excess reagents while the synthesized peptide remains attached to the insoluble support. This approach may be repeated as desired to create peptides of a defined sequence and length. Similar solid phase synthesis techniques may also be utilized in the synthesis of other organic compounds, such as polynucleotides and polysaccharides, to name a few.

Solid phase synthesis of peptides has traditionally been accomplished using Boc and Fmoc chemistry. Boc chemistry includes the use of t-butyloxycarbonyl chloride (tBocCl) or t-butyloxycarbonyl azide (tBocN₃), collectively referred to herein as “Boc”, as the protection agent for the amine group. Boc chemistry generally requires the use of weakly acidic fluids, such as tetrafluoroacetic acid (“TFA”) to deprotect the peptide (i.e., to remove Boc from the amine terminus of the peptide), and the use of strongly acidic fluids (e.g., hydrofluoric acid) to cleave the synthesized peptide from the insoluble support. Peptide synthesis systems utilizing Boc chemistry may require special materials, plumbing and/or environmental precautions to facilitate use of strongly acidic solutions. Various peptide synthesis systems using solid phase synthesis techniques and Boc chemistry are known, including those described in U.S. Pat. No. 3,531,258 to Merrifield et al., U.S. Pat. No. 4,192,798 to Verlander et al., U.S. Pat. No. 4,362,699 to Verlander et al., U.S. Pat. No. 4,746,490 to Saneii, U.S. Pat. No. 4,748,002 to Neimark et al., U.S. Pat. No. 5,362,447 to Nokihara and PCT Publication No. WO90/02605 to Morten et al., each of which are incorporated herein by reference in their entirety.

Fmoc chemistry generally includes the use of 9-fluorenylmethyloxycarbonyl (“Fmoc”) to protect the amine terminus of incoming amino acids during peptide synthesis. Fmoc chemistry is desirable in that a basic fluid (e.g., piperidine) may be utilized to deprotect the peptide (i.e., to remove Fmoc from the amine terminus of the peptide) and a weakly acidic fluid (e.g., TFA) may be used to cleave the synthesized peptide from the insoluble support. Thus, the use of Fmoc chemistry enables the use of less corrosive solvents during peptide synthesis. Various peptide synthesis systems using solid phase synthesis techniques and Fmoc chemistry are known, including those described in U.S. Pat. No. 4,362,699 to Verlander et al. and PCT Publication No. WO90/02605 to Morten et al.

Other reagents may also be used during solid phase peptide synthesis. For example, one or more coupling reagents, such as dicyclohexylcarbodiimide (“DCC”), N-hydroxybenzotriazole (“HOBt”), 2-(6-Nitro-1-oxy-benzotriazol-3-yl)-1,1,3,3-tetramethyluronium hexafluorophosphate (“NBTU”), and N,N-Diisopropylethylamine (“DIEA”) may be utilized to increase the reactivity of the carboxyl terminus of the incoming amino acid. Also, various solvents, including 1-methyl-2-pyrrolidone (“NMP”), dichloromethane (“DCM”), and ethanol (“EtoH”) may be used to wash the peptide and any intermediates, and to remove excess reagents from the reaction chamber and chemical delivery lines. Similar chemicals may be used in the synthesis of other organic compounds. Thus, a wide variety of chemicals may be utilized during solid phase synthesis.

Various systems exist for supplying solid phase synthesis chemicals to a reaction vessel. In systems where the chemicals are directed into the reaction vessel using shared line(s), the flow of numerous chemicals through such systems can result in cross contamination of these chemicals. Moreover, the liquid measurement techniques utilized during solid phase synthesis needs to be sufficiently accurate. Such cross contamination and/or a low dispensing accuracy can result in undesired reactions, by-products and low yield.

Automating the delivery of the numerous chemicals can be a non-trivial task as multiple components may require controlled operation and/or various processes may have to be monitored to ensure that the synthesis is proceeding in the appropriate manner. A computer can be utilized to assist in automating the solid phase synthesis, but the preparation of associated software is also non-trivial due to the relatively infinite number of organic compounds (e.g., peptide, polynucleotide and polysaccharide sequences) that can be produced.

### SUMMARY OF THE INVENTION

In view of the foregoing, one objective of the present invention is to provide automated solid phase synthesis with reduced or no cross-contamination. Another object of the present invention is to provide for accurate dispensing of chemicals (e.g., amino acids, reagents, solvents, etc.) used during solid phase synthesis. Yet another object of the present invention is to provide for flexible control of automated solid phase synthesis. Yet another object of the present invention is to automate or semi-automate the production of chemicals utilized in solid phase synthesis.

One or more of these objects may be achieved by the inventive solid phase synthesis system and methods of the present invention. In one aspect of the invention, a solid phase synthesis system includes a reaction vessel, a structural unit chemical dispensing unit, a synthesis chemical dispensing unit, and a controller. The structural unit chemical dispensing unit may be fluidly interconnectable to the reaction vessel via a first fluid interconnection line, and the synthesis chemical dispensing unit may be fluidly interconnectable to the reaction vessel via a second fluid interconnection line, the second fluid interconnection line being fluidly isolated from the first fluid interconnection line. The reaction vessel may be adapted to receive structural unit chemicals and synthesis chemicals. In one embodiment, the reaction vessel is adapted to operate at or near atmospheric pressure (e.g., from about 0.5 atm to about 2.5 atms). The controller may be communicably interconnectable to the structural unit chemical dispensing unit and the synthesis chemical dispensing unit, the controller being operable to send signals to control delivery of structural unit chemicals and synthesis chemicals. In one embodiment, the controller may be operable to control delivery of structural unit chemicals from the structural unit chemical dispensing unit to the reaction vessel via the first fluid interconnection line. In a related embodiment, the controller may be operable to control delivery of synthesis chemicals from the synthesis chemical dispensing unit to the reaction vessel via the second fluid interconnection line.

The structural unit chemical dispensing unit may include a plurality of containers, each of the containers being adapted to contain structural unit chemicals (e.g., amino acids, nucleotides, saccharides, etc.). The structural unit chemical dispensing unit may include a multi-position valve, which includes a plurality of inlet ports and an outlet port, with the inlet ports being fluidly interconnected to a corresponding one of the plurality of containers. The structural unit chemical dispensing unit may include a pump, which may be fluidly interconnectable to the outlet port of the multi-position valve and the first fluid interconnection line. Thus, the structural unit chemical dispensing unit may be operable to dispense a plurality of structural unit chemicals to the reaction vessel. The structural unit chemical dispensing unit may further include a controllable thermal unit operable to control a temperature of the structural unit chemicals within the plurality of containers. One or more of the multi-position valve, the pump and the controllable thermal unit may be communicably interconnectable to the controller, where the controller is operable to send signals to control one or more of the multi-position valve, the pump and the controllable thermal unit.

The synthesis chemical dispensing unit may include at least one container, which is adapted to contain a synthesis chemical (e.g., non-structural unit chemicals, such as reagents or solvents). The synthesis chemical dispensing unit may include at least one pump fluidly interconnectable to the at least one container. The at least one pump may also be fluidly interconnectable to the second fluid interconnection line, where the pump is operable to dispense synthesis chemicals from the at least one container to the reaction vessel via the second fluid interconnection line. The at least one pump may be communicably interconnectable to the controller, and the controller may be operable to send signals to control the pump.

Thus, as the first and second fluid lines may be fluidly isolated from one another, the solid phase synthesis system may be operable to deliver a plurality of structural unit chemicals and synthesis chemicals to the reaction vessel, wherein such structural unit chemicals and synthesis chemicals are fluidly isolated from one another prior to entering the reaction vessel, thereby restricting cross-contamination of such chemicals. Moreover, utilizing the controller with such dispensing units and/or reaction vessel enables the automated or semi-automated operation of the solid phase synthesis system.

The pump of the structural unit chemical dispensing unit and/or the synthesis chemical dispensing unit may be any pump adapted to dispense fluids to the reaction vessel via the first fluid interconnection line. In one arrangement, the pump comprises a syringe adapted to dispense liquid volumes of from about 25 microliters to about 50 milliliters and with a dispensing precision of at least about 2 microliters for every milliliter dispensed. Thus, in this arrangement, the structural unit chemical dispensing unit and/or the synthesis chemical dispensing unit may be operable to dispense chemicals to the reaction vessel with a relatively high accuracy, thereby obviating the need for flow meters or other measurement devices within such dispensing units and/or fluid interconnection lines. Eliminating such measurement devices is advantageous because the synthesis system can be operated without feedback from the valves and/or pumps.

In one arrangement, the structural unit chemical dispensing unit includes a rinsing container fluidly interconnectable to the pump. The rinsing container may be adapted to include a rinsing solution. In one embodiment, the pump may be operable to dispense the rinsing solution in the rinsing container to the reaction vessel via the first fluid interconnection line and the multi-position valve. Thus, the structural unit chemical dispensing unit may be able to cleanse the multi-position valve and/or the fluid interconnection lines, thereby further restricting cross-contamination.

The synthesis chemical dispensing unit may comprise any of the components discussed above in relation to the structural unit chemical dispensing unit. In one embodiment, the synthesis chemical dispensing unit comprises a pump fluidly interconnectable to a plurality of containers, said containers comprising one of a solvent and a reagent. In another embodiment, the synthesis chemical dispensing units may comprise a multi-position valve arrangement, as discussed above in relation to the structural unit chemical dispensing unit, to facilitate the provision of a plurality of reagents and/or solvents from the synthesis chemical dispensing unit. In this embodiment, the synthesis chemical dispensing unit may also comprises a rinsing container fluidly interconnectable to the pump, as described above in relation to the structural unit chemical dispensing unit.

The solid phase synthesis system may include one or more reaction vessels, one or more structural unit chemical dispensing units, and/or one or more synthesis chemical dispensing units, with each of such reaction vessels and/or dispensing units including any of the above described components. In one arrangement, the solid phase synthesis system includes a first and second reaction vessel, a structural unit chemical dispensing unit, and first, second and third synthesis chemical dispensing units. In this arrangement, the solid phase synthesis may also include a controller communicably interconnectable to any one of the first and/or second reaction vessels, the structural unit dispensing unit and/or the first, second and/or third synthesis chemical dispensing units to control the operation of such reaction vessels and dispensing units.

In this arrangement, the first reaction vessel may be fluidly interconnectable to the structural unit chemical dispensing unit via a first fluid interconnection line. The first reaction vessel may be fluidly interconnectable to the first synthesis chemical dispensing unit and the second synthesis chemical dispensing unit via second and third fluid interconnection lines, respectively. The second fluid interconnection line may be fluidly isolated from the first fluid interconnection line and the third fluid interconnection line. Additionally, the third fluid interconnection line may be fluidly isolated from the first fluid interconnection line. Thus, the first, second, and third fluid interconnection lines may be fluidly isolated from one another, thereby restricting cross-contamination between such dispensing units.

Further in this arrangement, the first synthesis chemical dispensing unit may be operable to dispense a first set of synthesis chemicals to the first reaction vessel via the second fluid interconnection line. The second synthesis chemical dispensing unit may be operable to dispense a second set of synthesis chemicals to the reaction vessel via the third fluid interconnection line. In one embodiment, the first set of synthesis chemicals comprises a first coupling agent and a first solvent. In a related embodiment, the second set of synthesis chemicals comprises a second coupling agent and a second solvent. Thus, the solid phase synthesis system may be operable to provide a plurality of coupling agents and solvents to the reaction vessel with restricted or no cross-contamination between the coupling agents and/or the structural unit chemicals.

Further in this arrangement, the second reaction vessel may be adapted to contain a solid phase support and be fluidly interconnectable to the first reaction vessel via a fourth fluid interconnection line. The second reaction vessel may be fluidly interconnectable to the third synthesis chemical dispensing unit via a fifth fluid interconnection line, this fifth fluid interconnection line being fluidly isolated from the first, second, and third interconnection lines. The third synthesis chemical dispensing unit may be operable to dispense a third set of synthesis chemicals to the second reaction vessel via this fifth fluid interconnection line. In one embodiment, the third set of synthesis chemicals comprises a deprotection agent and a third solvent. In another embodiment, the third set of synthesis chemicals comprises a cleaving agent and a third solvent. Thus, the solid phase synthesis system is operable to deliver a plurality of solvents to the second reaction vessel between subsequent couplings to rinse the produced organic compound prior to coupling with a structural unit chemical, thereby restricting undesired side reactions. Also, the solid phase synthesis system is operable to deliver a deprotection agent to the second reaction vessel, separate from the delivery of the coupling agent, thereby restricting cross-contamination between the deprotection agent and coupling agent reactions. Additionally, the first and/or second reaction vessels may be rinsed with solvents while the other reaction vessel is coupling and/or deprotecting, respectively, thereby increasing production rates.

In one arrangement, the solid phase synthesis system includes a chemical solution synthesis unit, the chemical solution synthesis unit including a dispenser and an in-unit conveyor. The dispenser may be adapted to dispense selected amounts of chemical to one or more containers. The in-unit conveyor may be adapted to move the containers from a first position to a second position, wherein in the first position the container may be adapted to receive chemicals from the dispenser. In one aspect, the dispenser may comprise a motorized unit and a syringe adapted for engagement therewith, wherein the dispenser may be adapted to dispense selected quantities of solid-phase chemical to one or more containers. In one embodiment, the in-unit conveyor may include a turntable and/or robotic elements for moving the containers to and/or from the first position.

In one aspect, the chemical solution synthesis unit may include a measurer adapted to measure an amount of chemical dispensed from the dispenser to a container or containers. In one embodiment, the measurer comprises a tarable (i.e., capable of being tared) electric scale. In another embodiment the measurer comprises an electronic and/or optical sensor adapted to detect an amount of fluid contained in the container.

In a further aspect, the chemical solution synthesis unit may include an agitator adapted to agitate chemicals contained in the dispenser. In one embodiment, the agitator is adapted to physically agitate chemicals in the dispenser (e.g., via a rotatable arm adapted to physically and repeatedly impact the side of the container). In another embodiment the agitator may comprise a stir rod. In another embodiment, the agitator is adapted to agitate the chemical within the dispenser via electronic, optic and/or magnetic means (e.g., via heating or otherwise exciting such chemicals via electromagnetic means).

The controller may also be communicably interconnectable to the chemical solution synthesis unit. In one embodiment, the controller is communicably interconnectable to the dispenser and the in-unit conveyor and is operable to send signals to the dispenser and the in-unit conveyor to control the dispenser and in-unit conveyor. In a related embodiment, the controller may be communicably interconnectable to the agitator to control the operation of the agitator. In one embodiment, the controller is communicably interconnectable to and operable to receive signals from the measurer, thereby enabling the controller to calculate an amount of chemical dispensed from the dispenser. Thus, in this arrangement the solid phase synthesis system may be operable to automatically or semi-automatically produce chemicals (e.g., structural unit chemicals and/or synthesis chemicals) that may be utilized by the solid phase synthesis system (e.g., by a structural unit chemical dispensing unit and/or a synthesis chemical dispensing unit), thereby increasing productivity of the system.

The chemical solution synthesis unit may include any number of dispensers and conveyors to enable automated or semi-automated production of chemicals. In one arrangement, the chemical solutions synthesis unit includes a first dispensing unit, a second dispensing unit, a global conveyor, and a source chemical array. The first dispensing unit may include any of the above described dispenser, in-unit conveyor, agitator, and/or measurer. The second dispensing unit may also include any of the above described dispenser, in-unit conveyor, agitator, and/or measurer.

In a particular embodiment, the first dispensing unit includes a first dispenser adapted to dispense selected amounts of solid phase chemical into the containers. The second dispensing unit includes a second dispenser adapted to dispense a selected amount of liquid phase chemical into the containers for mixing with the solid phase chemical dispensed from the first dispenser, thereby enabling the production of one of a structural unit chemical and a synthesis chemical. The produced structural unit chemical may be employed by the structural unit chemical dispensing unit. The produced synthesis chemical may be employed by the synthesis chemical dispensing unit. In one embodiment, the first position corresponds to the first dispenser, and the second position corresponds to the second dispenser, wherein the in-unit conveyor is adapted to position the containers from the first position to the second position. Thus, the chemical solution synthesis unit may be operable to produce chemicals utilizable by the solid phase synthesis system.

The source chemical array may include a plurality of chemicals, each of these plurality of chemicals being contained in a separate one of a plurality receptacles. These plurality of chemicals may be employable to produce structural unit chemicals and/or synthesis chemicals. Moreover, the receptacles may be adapted for engagement with a dispenser of a dispensing unit. In one arrangement, the dispenser may comprise a motorized unit and the plurality of receptacles may comprise syringes adapted for engagement with the motorize unit. In one embodiment, each of the syringes includes a pre-determined amount of one of the plurality of chemicals. Thus, the chemical solution synthesis unit may be operable to provide chemicals to the dispenser to enable the production of other chemicals that may be utilized by the solid phase synthesis system. In one embodiment, the global conveyor may be adapted to convey selected ones of the plurality of receptacles from the source chemical array to at least a first dispensing unit. The conveyor may also be adapted to remove spent ones of the receptacles from at least the first dispensing unit.

In another embodiment, the global conveyor may be adapted to convey the containers from a first and/or second dispensing unit to one or more of the structural unit chemical dispensing unit and/or the synthesis chemical dispensing unit. In a related embodiment, the global conveyor may be adapted to convey the containers from the first dispensing unit to the second dispensing unit (e.g., to enable mixing of a solid phase chemical dispensable from the first dispensing unit with a liquid phase chemical dispensable from the second dispensing unit). Thus, the solid phase synthesis system may be operable to automate production of chemicals utilizable in a solid phase synthesis system.

In related embodiment, the controller may be communicably interconnectable to the global conveyor, wherein the controller is operable to send signals to control the conveyor (e.g., to control positioning of the containers, such as to and/or from any of the dispensing units of the chemical solution synthesis unit, the structural unit chemical dispensing unit and/or the synthesis chemical dispensing unit). In one embodiment, the controller may be operable to control the chemical solution synthesis unit in parallel with the control of at least one of the structural unit chemical dispensing unit and the synthesis chemical dispensing unit.

As noted, the solid phase synthesis system may include one or more electronically controllable pumps, one or more electronically controllable valves, containers adapted to contain structural unit chemicals and synthesis chemicals, and one or more reaction vessels. To further facilitate automation of the solid phase synthesis system, the solid phase synthesis system may include software and corresponding hardware adapted to interface with such components.

More particularly, and in one aspect, the solid phase synthesis system may include a command routine, a processor, a translation routine, and an interface. The command routine may include a plurality of higher-level commands arranged in a preselected order, each of these higher-level commands including one or more lower-level commands also arranged in a preselected order, these lower-level commands including instructions corresponding to a least one of activating a pump and positioning a valve. The processor may be operable to execute the command routine. The translation routine may be executable by the processor to translate the lower-level commands to electronic signals. The interface may be operable to direct the electronic signals to the one or more controllable pumps and the one or more controllable valves in order to operate the one or more controllable pumps and the one or more controllable valves in accordance with the command routine, thereby directing preselected amounts of structural unit chemicals and/or synthesis chemicals from containers to a reaction vessel in a preselected order. In one embodiment, the arrangement of the valves and pumps within the reaction system is such that feedback from the reaction system is not required to operate the system. Thus, a command routine may be executable without feedback from the solid phase synthesis system.

In one arrangement, the lower-level commands may include parameters and these parameters may include information identifying a particular pump or valve included in the solid phase synthesis system. In one embodiment, the lower-level commands may include a delay command associated with delaying the time between execution of prior and subsequent lower-level commands.

In another arrangement, each of the higher-level commands may include one or more intermediate level commands arranged in a preselected order, wherein the intermediate level commands include one or more of the lower-level commands. In one embodiment, at least one of the intermediate level commands does not include any lower-level commands and such intermediate level commands include instructions corresponding to at least one of activating a pump and positioning a valve.

Thus, the solid phase synthesis system via the controller provides a flexible system that enables the quick and efficient synthesis of nearly infinite organic compounds of a desired structure in an automated fashion. More particularly, since a higher level command may reference a plurality of intermediate level and/or lower level commands, a variety of higher number commands can be efficiently prepared simply by referencing one or more intermediate level and/or lower level commands. Moreover, since the intermediate level commands may include a plurality of lower level commands that translate to specific operations of the system, a variety of intermediate level commands can be efficiently prepared simply by referencing one or more lower level commands. Thus, a command routine can be prepared by placing a series of higher level commands in a preselected order without requiring the programming of specific parameters for each desired synthesis, thereby decreasing programming time and increasing productivity.

In one arrangement, the interface may be interconnectable with a general purpose computer, and the interface may include an RS-232 interface. Further, the command routine may be executable by the general purpose computer. In a related embodiment, the command routine may be specified within a spreadsheet program on the general purpose computer. In another related embodiment, the command routine may further include a set page comprising user-defined names and reaction system functions corresponding with these user-defined names. Thus, the solid phase synthesis system may be easily programmable to facilitate production of nearly infinite organic compounds.

Associated methods are also included within the scope of the present invention. More particularly, a method of controlling a solid phase synthesis system is provided, the solid phase synthesis system including one or more controllable pumps, one or more controllable valves, containers adapted to contain structural unit chemicals and synthesis chemicals, and one or more reaction vessels. The method includes executing a command routine, the command routine including a plurality of higher-level commands arranged in a preselected order, each of the higher-level commands corresponding to one or more lower-level commands arranged in a preselected order, the lower-level commands including instructions corresponding to at least one of activating a pump and positioning a valve. The method further includes translating at least the lower-level commands to electronic signals, and directing these electronic signals via an interface to one or more controllable pumps and one or more controllable valves to operate the one or more controllable pumps and one or more controllable valves in accordance with the command routine to direct preselected amounts of structural unit chemicals and synthesis chemicals from the containers to a reaction vessel in a preselected order. The method may further include the step of receiving a user-defined name and associating this user-defined name with one an intermediate-level and/or lower-level command.

In another aspect, a method of producing an organic compound of a desired structure is provided, the method including the steps of executing a command to direct a first quantity of a structural unit chemical to a first reaction vessel via a first fluid interconnection line and executing a command to direct a first quantity of a synthesis chemical to the first reaction vessel via a second fluid interconnection line, the second fluid interconnection line being fluidly isolated from the first fluid interconnection line. The method further includes the steps of executing a command to direct this first quantity of structural unit chemical and this first quantity of synthesis chemical to a second reaction vessel via a third fluid interconnection line, and executing a command to direct a second quantity of structural unit chemical to the first reaction vessel via the first fluid interconnection line. The method further includes the step of executing a command to direct a second quantity of synthesis chemical to the second reaction vessel via a fourth fluid interconnection line, this fourth fluid interconnection line being fluidly isolated from both the first and second fluid interconnection lines.

In one embodiment, the method may further include the step of executing a command to direct a third quantity of synthesis chemical to the first reaction vessel after the step of executing a command to direct the second quantity of structural unit chemical to the first reaction vessel step. The method may further include the step of executing a command to direct the second quantity of synthesis chemical out of the second reaction vessel after the step of executing a command to direct the second quantity of a synthesis chemical to the second reaction vessel step. The method may further include the step of executing a command to direct the second quantity of structural unit chemical to the second reaction vessel via the third fluid interconnection line after the step of executing a command to direct a second quantity of the structural unit chemical to the first reaction vessel step.

Additional aspects and advantages of the present invention will become apparent to those skilled in the art upon consideration of the further description provided hereinbelow.

### BRIEF DESCRIPTION OF THE DRAWINGS

FIG. 1 is a schematic view of one embodiment of a synthesis system useful in accordance with the present invention.

FIG. 2 is a schematic view of one embodiment of a reaction unit and associated connections of the synthesis system of FIG. 1.

FIG. 3 is a schematic view of one embodiment of structural unit chemical dispensing unit and associated connections of the synthesis system of FIG. 1.

FIG. 4 is a schematic view of one embodiment of a pump and associated connections of the structural unit chemical dispensing unit of FIG. 3.

FIG. 5 is a is a schematic view of one embodiment of a synthesis chemical dispensing unit and associated connections of the synthesis system of FIG. 1.

FIG. 6 is a schematic view of one embodiment of a controller and associated connections of the synthesis system of FIG. 1.

FIG. 7 is a schematic view of one embodiment of instructions of the controller of FIG. 6.

FIG. 8 illustrates one embodiment of a command routine of the instructions of FIG. 7, including a lower level command screen, an intermediate level command screen, and a higher level command screen view.

FIG. 9 illustrates a screen view of one embodiment of a lower level command screen associated with another command routine.

FIG. 10 illustrates a screen view of one embodiment of a lower level command screen associated with another command routine.

FIG. 11 illustrates a screen view of one embodiment of a set-up screen associated with a command-routine.

FIG. 12 illustrates one embodiment of a synthesis system useful in accordance with the present invention.

FIG. 13a illustrates a schematic view of one embodiment of a synthesis system including a chemical solution synthesis unit.

FIG. 13b illustrates a schematic view of one embodiment of the chemical solution synthesis unit of FIG. 13a.

FIG. 13c illustrates a schematic view of one embodiment of a first dispensing unit of the chemical solution synthesis unit of FIG. 13b.

FIG. 13d illustrates a side view of one embodiment of a first dispensing unit of FIG. 13b.

FIG. 13e illustrates one embodiment of chemical being dispensed from the first dispensing unit of FIG. 13d.

FIG. 13f is one embodiment of a second dispensing unit of the chemical solution synthesis unit of FIG. 13b.

FIG. 14 is one controller interconnection embodiment in accordance with the present invention.

### DETAILED DESCRIPTION

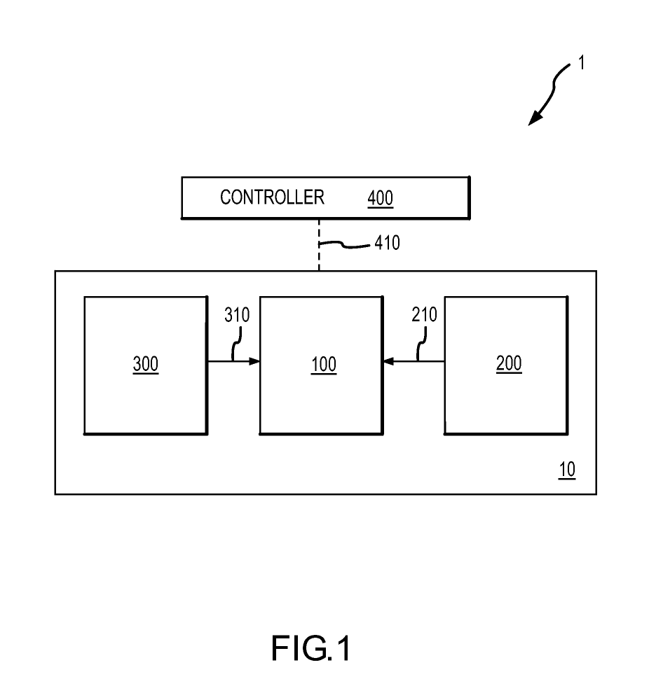

Reference is now made to the accompanying drawings, which at least assist in illustrating various pertinent features of the present invention. Referring now to FIG. 1, a synthesis system 1 useful in accordance with the present invention is illustrated. The synthesis system 1 generally includes a reaction system 10 and a controller 400 communicably interconnectable to various portions of the reaction system 10 via one or more controller connection cable(s) 410. The reaction system includes a reaction unit 100, a structural unit chemical dispensing unit 200, and a synthesis chemical dispensing unit 300. The structural unit chemical dispensing unit 200 may be operable to dispense structural unit chemicals (e.g., amino acids, nucleotides, etc.) to the reaction unit 100, and may be upstream of and fluidly interconnectable to the reaction unit 100 via a first interconnection line 210. The synthesis chemical dispensing unit 300 may be operable to dispense synthesis chemicals (e.g., reagents and/or solvents) to the reaction unit 100, and may be upstream of and fluidly interconnectable to the reaction unit 100 via a second fluid interconnection line 310. The first and second fluid interconnection lines 210, 310 may be fluidly isolated from one another. Fluidly isolating the first and second fluid interconnection lines 210, 310 from one another assists in restricting cross-contamination between the synthesis chemicals and the structural unit chemicals.

The controller 400 may be communicably interconnectable to the structural unit chemical dispensing unit 200 and the synthesis chemical dispensing unit 300 via the controller connection cable(s) 410. The controller 400 may also be communicably interconnectable to the reaction unit 100 via the controller connection cable(s) 410. As discussed in further detail below, the controller 400 may be operable to send signals to control the structural unit chemical dispensing unit 200, the synthesis chemical dispensing unit 300, and/or the reaction unit 100. For example, the controller 400 may send signals to the structural unit chemical dispensing unit 200 and/or the synthesis chemical dispensing unit 300 and/or the reaction unit 100 to control the sequential delivery of structural unit chemicals and/or synthesis chemicals to the reaction unit 100 and/or to control operation of the reaction unit 100 to synthesize various organic compounds (e.g., peptides, polynucleotides, etc.). As is discussed in further detail below, control software may be utilized with the controller 400 to facilitate flexible and automated or semi-automated organic compound synthesis.

As noted, the controller connection cable(s) 410 may communicably interconnect the controller 400 to the reaction system 10. The controller connection cable(s) 410 may, for example, be an electrically conductive cable including one or more electrically conductive wires/lines or may be an optical cable including one or more optic fibers. In other embodiments, the controller 400 may communicate with the reaction system 10 or particular components thereof without the controller connection cable(s) 410, such as by wireless communication (e.g., via wireless radio frequency or over-the-air optical).

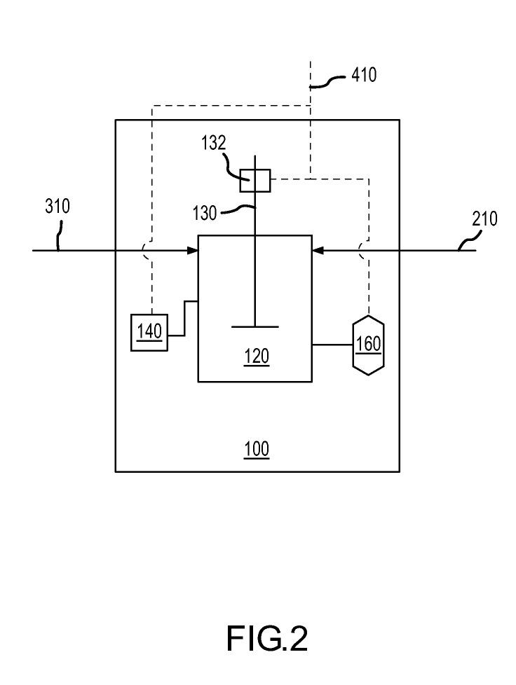

Referring now to FIG. 2, the reaction unit 100 may include a reaction vessel 120 downstream of and fluidly interconnectable to the first and second fluid interconnection lines 210, 310. The reaction vessel 120 may, for example, be a vessel designed for operation at near atmospheric pressures (e.g., between 0.5 atm and 2.5 atms). The reaction vessel 120 may also be interconnected to an agitation source 130, such as a stir rod, for agitating the contents of the reaction vessel 120 to increase mass transfer and reaction kinetics within the reaction vessel 120. The agitation source 130 may include a motor 132 for providing motive force to the agitation source 130, and may be communicably interconnectable to the controller 400 via, for example, the controller connection cable(s) 410.

The reaction unit 100 may also include a sensor 140 for determining the status of the reaction within the reaction vessel 120. For example, the sensor 140 may comprise an optical sensor adapted to project light into the reaction medium within the reaction vessel 120, such as, for example, an optical sensor capable of projecting ultraviolet light and determining the status of a chemical reaction using absorption or florescence spectroscopy. In other embodiments, the sensor 140 may comprise an electrical sensor adapted to test the conductance of the reaction medium to determine the status of the chemical reaction. The controller 400 may be communicably interconnected to the sensor 140, via, for example, the controller connection cable(s) 410, to control such sensor 140 and/or provide signals thereto and/or receive signals therefrom (e.g., absorption readings).

The reaction unit 100 may further include a controllable thermal unit 160. The controllable thermal unit 160 may be interconnected to the reaction vessel 120 to provide thermal energy thereto. For example, the controllable thermal unit 160 may be adapted to increase or decrease the temperature of the reaction vessel 120 (e.g., by electrically heating or refrigerating the reaction vessel 120). The controller 400 may be communicably interconnected to the controllable thermal unit 160, via, for example, the controller connection cable(s) 410, to control such unit 160 and/or provide signals thereto and/or receive signals therefrom (e.g., temperature readings).

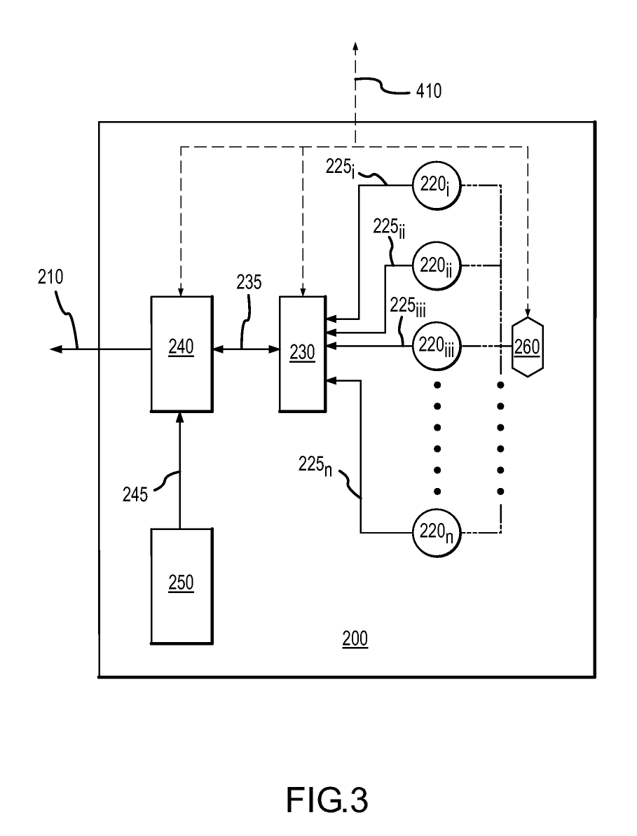

Referring now to FIG. 3, the structural unit chemical dispensing unit 200 may include a plurality of containers 220 (e.g., containers 220ᵢ-220ₙ) fluidly interconnectable to a multi-position valve 230, which may be fluidly interconnectable to a pump 240. The structural unit chemical dispensing unit 200 may also include a rinsing solution container 250 fluidly interconnectable to the pump 240. The pump 240 may be fluidly interconnected to the reaction unit 100 via the first fluid interconnection line 210. A controllable thermal unit 260 may be interconnected to the plurality of containers 220. Each of the multi-position valve 230, pump 240, and controllable thermal unit 260 may be communicably interconnected to the controller 400 via, for example, the controller connection cable(s) 410.

The plurality of containers 220 may each include a structural unit chemical for use in creating organic compounds (e.g., amino acids for creating peptides, nucleotides for creating polynucleotides, etc.). The containers 220 may often include differing structural unit chemicals, but in some circumstances may include an equivalent structural unit chemical. As used herein, the term “structural unit chemical” refers to any chemical that acts as a structural unit for an organic compound. For example, amino acids are the structural unit chemicals for peptides, nucleotides are the structural unit chemicals for polynucleotides, and saccharides are the structural unit chemicals for polysaccharides. Other structural unit chemicals will be evident to those skilled in the art.

The plurality of containers 220 may be fluidly interconnected to the multi-position valve 230 via multi-position valve interconnection lines 225 (e.g., lines 225ᵢ-225ₙ). The multi-position valve 230 may be any valve adapted to receive structural unit chemicals from the plurality of containers 225. The multi-position valve 230 may be further adapted to dispense one of the structural unit chemicals through the valve 230 and to the pump 240 via a pump interconnection line 235. In this regard, the multi-position valve may include a plurality of input ports (e.g., “n” input ports) and at least one output port. In one embodiment, the multi-position valve 230 is an electrically controllable rotary valve. The multi-position valve 230 may also be communicably interconnected to the controller 400 via controller connection cable(s) 410, and may be controllable by the controller 400 to automate delivery of structural unit chemicals therethrough.

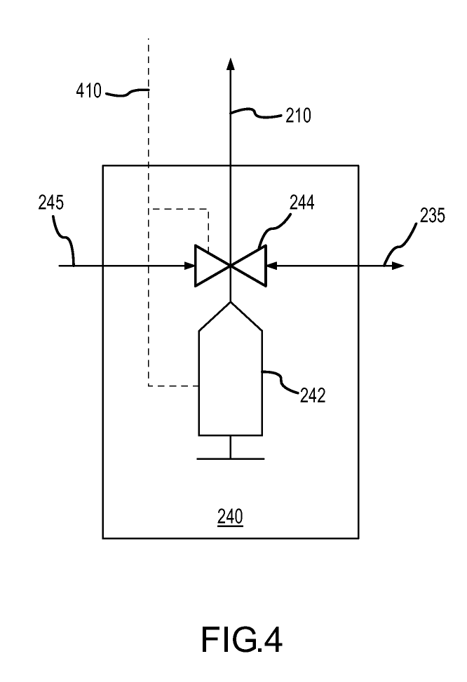

The pump 240 may be fluidly interconnected to the multi-position valve 230 via the pump interconnection line 235. The pump 240 may also be fluidly interconnectable to the rinsing solution container 250 via a rinsing solution interconnection line 245. The pump 240 may be further fluidly interconnectable to the first fluid interconnection line 210. More particularly and with reference to FIG. 4, the pump 240 may comprise a pump valve 244 fluidly interconnectable to each of the pump interconnection line 235, the rinsing solution interconnection line 245, and the first fluid interconnection line 210. The pump valve 244 may be further fluidly interconnectable to a liquid dispenser, such as an automated syringe 242. The pump valve 244 and/or syringe 242 may be controllable by the controller 400 to automate delivery of chemicals.

In operation and with reference to FIGS. 1, 3 and 4, when the pump valve 244 is in an appropriate orientation, fluids from either the multi-position valve 230 or the rinsing solution container 250 may be drawn into the syringe 242 during retraction of a plunger of the syringe 242. Subsequently, the pump valve 244 may be moved to another orientation, wherein fluids contained in the syringe 242 may be dispensed to the reaction unit 100 via the first fluid interconnection line 210.

In one embodiment and with reference to FIGS. 1, 3 and 4, the pump 240 may be employed to dispense structural unit chemicals to the reaction unit 100. In this embodiment, the multi-position valve 230 and the pump valve 244 may first be positioned to enable flow of a selected structural unit chemical from one of the plurality of containers 220, through a corresponding multi-position valve interconnection line 225, multi-position valve 230, pump interconnection line 235, pump valve 244 and into the syringe 242 as the plunger of the syringe 242 is retracted. Subsequently, the pump valve 244 may be moved to another position, and the structural unit chemical contained in the syringe 242 may be dispensed to the reaction unit 100 via the first fluid interconnection line 210 as the plunger of the syringe 242 is advanced.

In another embodiment, the pump 240 may be employed to dispense a rinsing solution through the first fluid interconnection line 210 and into the reaction unit 100. In this embodiment, the pump valve 244 may be positioned to enable a rinsing solution (e.g., a solvent) from the rinsing solution container 250 to flow through the pump valve 244 and into the syringe 242 as the plunger of the syringe 242 is retracted. Subsequently, the pump valve 244 may be moved to another position, and the rinsing solution contained in this syringe 242 may be dispensed through the first fluid interconnection line 210 into the reaction unit 100 as the plunger of the syringe 242 is advanced. Use of a rinsing solution enables both the first fluid interconnection line 210 and the reaction unit 100 to be rinsed of previously used structural unit chemicals, which helps to reduce cross-contamination.

In a related embodiment, the pump 240 may further be employed to rinse the pump interconnection line 235, multi-position valve 230 and/or a multi-position valve interconnection line 225. In this embodiment, the pump valve 244 may be positioned to enable a rinsing solution from the rinsing solution container 250 to flow through the pump valve 244 and into the syringe 242 as the plunger of the syringe 242 is retracted. Subsequently, the pump valve 244 and multi-position valve 230 may be oriented to enable flow of the rinsing solution from the syringe 242 to and through at least a portion of the pump interconnection line 235 as the plunger of the syringe 242 is advanced. In a particular embodiment, the rinsing solution from the syringe 242 flows through at least the pump interconnection line 235 and the multi-position valve 230 so that the multi-position valve 230 and pump interconnection line 235 may be rinsed. In this regard, plunger advancement may cease prior to pushing chemicals within such multi-position valve 230 and/or pump interconnection line 235 into the corresponding container 220.

The rinsing solution container 250 may be any container adapted to contain a rinsing solution and interconnect with rinsing solution interconnection line 245. The rinsing solution may be any chemical (e.g., a synthesis chemical) adapted to rinse/cleanse various portions of the structural unit chemical dispensing unit 200 and/or the reaction unit 100 and/or the first fluid interconnection line 210. The fluid interconnection lines (e.g., lines 225, 234, 245 and 210) may comprise suitable tubing adapted to flow structural unit chemicals and synthesis chemicals therethrough.

The controllable thermal unit 260 may be utilized to heat or cool any of the containers 220 of the structural unit chemical dispensing unit 200. Additionally, the controllable thermal unit 260 may include any of the features of the controllable thermal unit 160 referenced in FIG. 2, and may be controllable by controller 400.

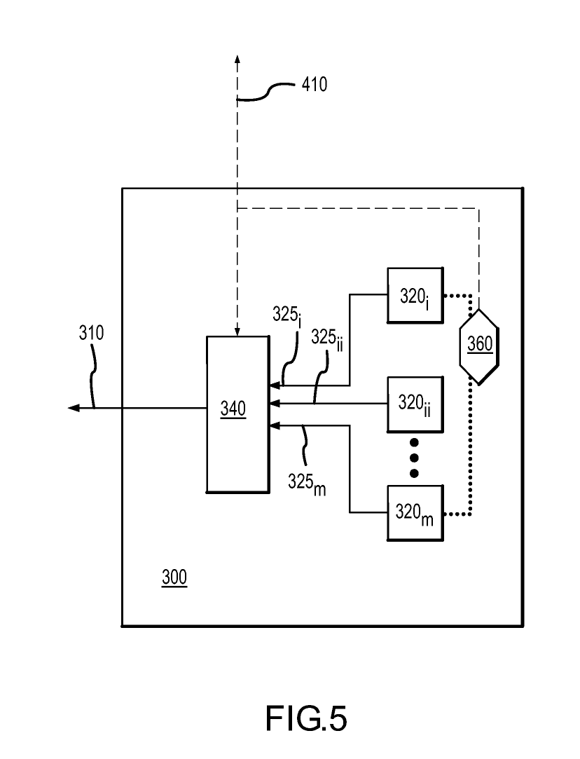

Referring now to FIG. 5, the synthesis chemical dispensing unit 300 may include containers 320 (e.g., 320ᵢ-320ₘ) fluidly interconnectable to a pump 340, which may be fluidly interconnectable to the second fluid interconnection line 310. The synthesis chemical dispensing unit 300 may also include a controllable thermal unit 360 adapted to control the temperature of one or more of the containers 320. A controller 400 (FIG. 1) may be communicably interconnectable to the pump 340 and the controllable thermal unit 360, for example, via the controller connection cable(s) 410.

The containers 320 may each include a synthesis chemical for use in synthesizing organic compounds. Often the containers 320 may include differing synthesis chemicals, but in some circumstances may include the same synthesis chemical. As used herein, the term “synthesis chemical” refers to a chemical other than structural unit chemicals, such as reagents (e.g., coupling agents, deprotection agents, cleaving agents) and solvents. Suitable synthesis chemicals for peptide, polynucleotide, and polysaccharide synthesis, to name a few, are known in the art.

The pump 340 may be fluidly interconnectable to each of the containers 320 via pump interconnection lines 325 (e.g., 325ᵢ-325ₘ). The pump 340 may also be fluidly interconnectable to the reaction unit 100 (FIG. 1) via the second fluid interconnection line 310. The pump 340 may include any of the features/components described above in relation to the pump 240 referenced in FIGS. 3 and 4. For example, the pump 340 may comprise a syringe and a pump valve (not shown) operable to sequentially dispense the synthesis chemicals from the containers 320 to the reaction unit 100. The pump 340 may also be interconnected to the containers 320 via a multi-position valve and/or a rinsing container, such as described above in reference to the structural unit chemical dispensing unit 200.

The syringes 242, 342 utilizable in the structural unit chemical dispensing unit 200 and/or synthesis chemical dispensing unit 300 may be any commercially available syringe adapted for integration with the structural unit chemical dispensing unit 200 and/or the synthesis chemical dispensing unit 300. In one embodiment, one or more of the syringes 242, 342 is adapted to dispense liquid volumes of from about 25 microliters to about 50 milliliters. In one embodiment, the syringes 242, 342 have a related precision of at least about ±2 microliters for every milliliter dispensed, more preferably of at least about ±1 micoliter for every milliliter dispensed, even more preferably of at least about ±0.5 microliter for every milliliter dispensed, and even more preferably of at least about ±0.1 microliter for every milliliter dispenses. The ability to dispense such liquid volumes with such precision may obviate the need for flow meters within any fluid interconnection lines.

The controllable thermal unit 360 of the synthesis chemical dispensing unit 300 may be utilized to heat or cool any of the containers 320 of the synthesis chemical dispensing unit 300. Additionally, the controllable thermal unit may include any of the features of the controllable thermal unit 160 referenced in FIG. 2, and may be controllable by controller 400.

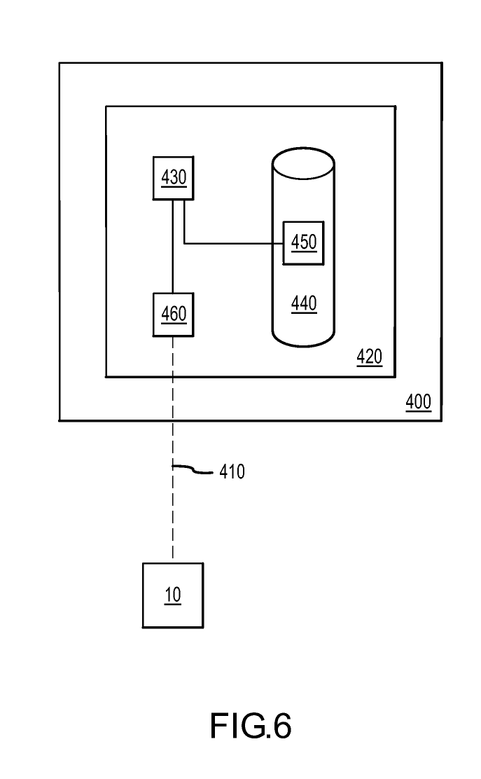

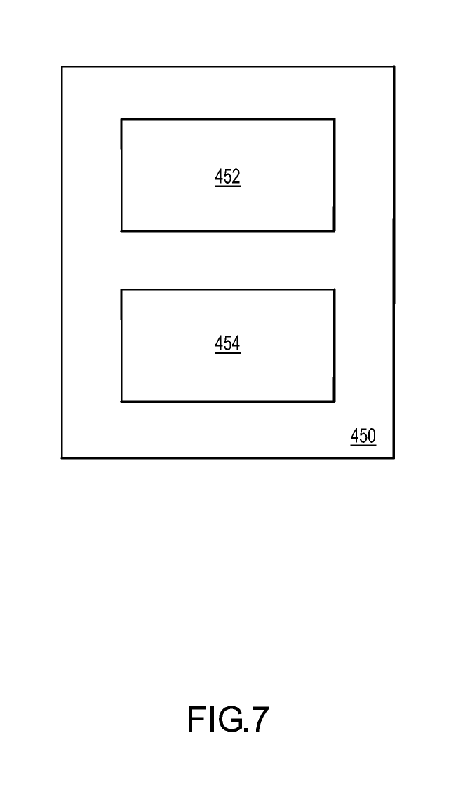

As noted above and with reference to FIG. 1, the synthesis system 1 may also include a controller 400, which may be adapted to send signals to one or more reaction units 100, one or more structural unit chemical dispensing units 200, and/or one or more synthesis chemical dispensing units 300. One embodiment of a controller 400 useful in accordance with the present invention is illustrated in FIG. 6. The controller 400 comprises a computer 420, which may include a processor 430 interconnectable to a data storage device 440 and an interface 460. The data storage device 440 may include instructions 450 adapted to be processed by the processor 430 and communicated to portions of the reaction system 10 via the interface 460 and controller connector cable 410. More particularly, the instructions 450 may include one or more executable routines adapted to automate the reaction system 10. For example and with reference to FIG. 7, the instructions 450 may include a command routine 452 and a translation routine 454.

The command routine 452 may include a plurality of higher level, intermediate level and/or lower level commands, each arranged in a preselected order. The higher level commands may be associated with general operations of a reaction system (e.g., dispense a structural unit chemical, soak a reaction vessel, deprotect a structural unit chemical, etc.). Each higher level command may include a plurality of intermediate level commands that are more particular to the desired operation of the system.

For example, an intermediate level command may be related to specific operations of the various valves, pumps, sensors, thermal units and agitators, to name a few. For example, the intermediate level commands may be associated with one of: positioning a valve (e.g., opening, closing or rotating a valve), activating or deactivating a pump (e.g., operating a pump in a first and/or second and/or other directions), activating or deactivating an agitator, activating or deactivating a thermal unit, and/or activating or deactivating a sensor, to name a few. The intermediate level commands may also include a time delay between two or more operations and may include parameters including information identifying a specific pump, valve, agitator, thermal unit, sensor and the like.

In other embodiments, an intermediate level command may include a plurality of lower level commands that are associated with specific actions of the various components of the reaction system 10 (e.g., specific valves, pumps, sensors, thermal units and agitators). For example, each lower level command may be associated with one of: positioning a valve (e.g., opening, closing or rotating a valve), activating or deactivating a pump (e.g., operating a pump in a first and/or second and/or other directions), activating or deactivating an agitator, activating or deactivating a thermal unit, and/or activating or deactivating a sensor, to name a few. The lower level commands may also include a time delay between two or more operations and may include parameters including information identifying a specific pump, valve, agitator, thermal unit, sensor and the like.

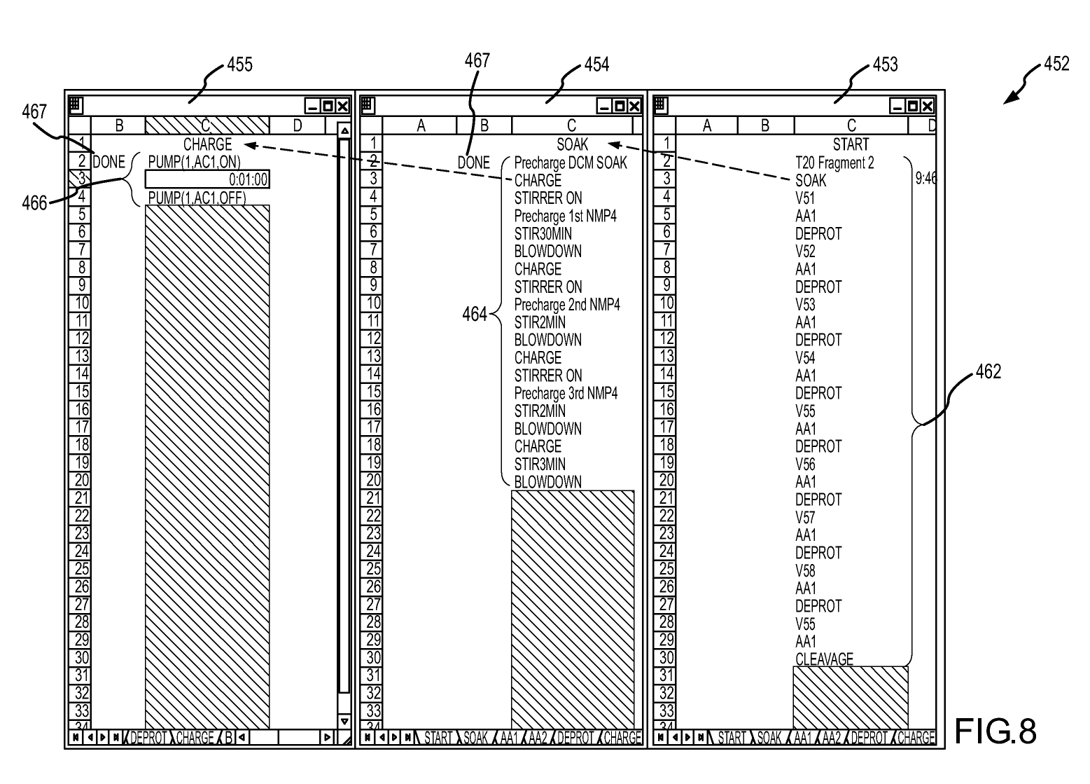

One embodiment of an exemplary command routine structure is illustrated in FIG. 8. The command routine 452 comprises a plurality of higher-level commands 462, as illustrated in the right-hand window 453 of FIG. 8. Each of the higher level commands 462 comprise intermediate level commands 464, as illustrated in the middle window 454 of FIG. 8. Each of the intermediate level commands 464 comprises lower level commands 466, as illustrated in the left-hand window 455 of FIG. 8. Underlying operating code (e.g., VISUAL BASIC, Microsoft Corp., Redmond, Wash., U.S.A.) may be utilized to execute the higher, intermediate and lower level commands 462, 464, 466 in the preselected order.

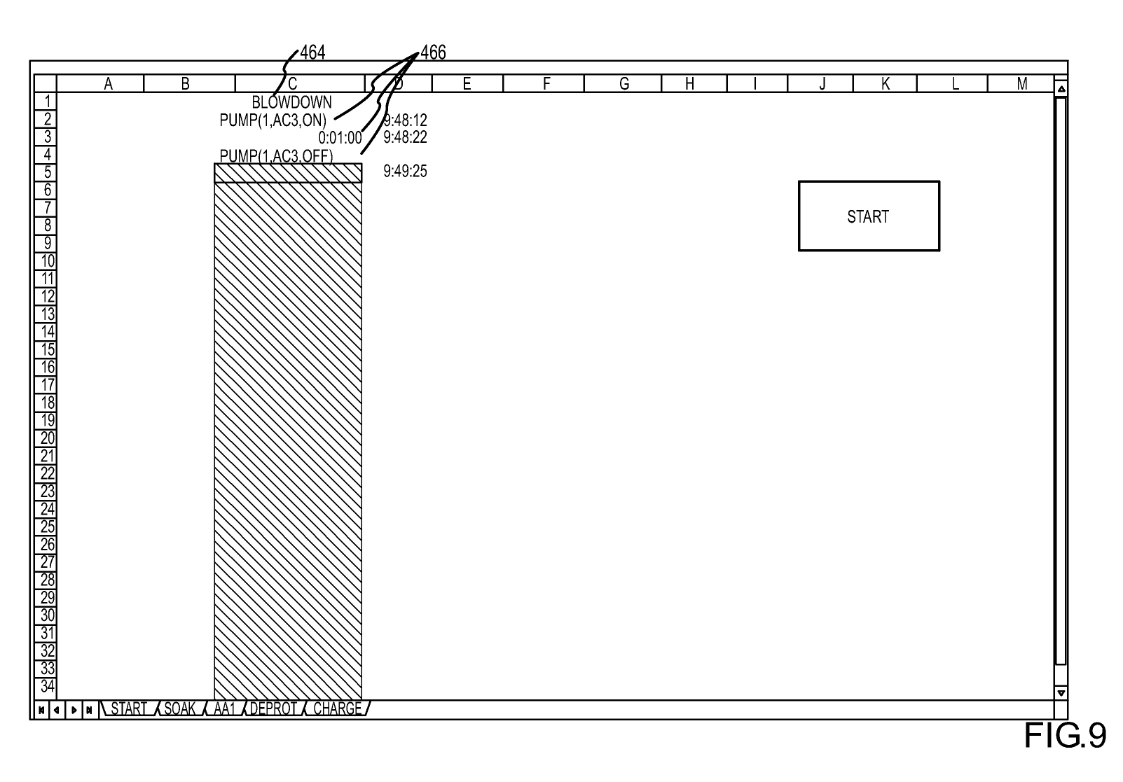

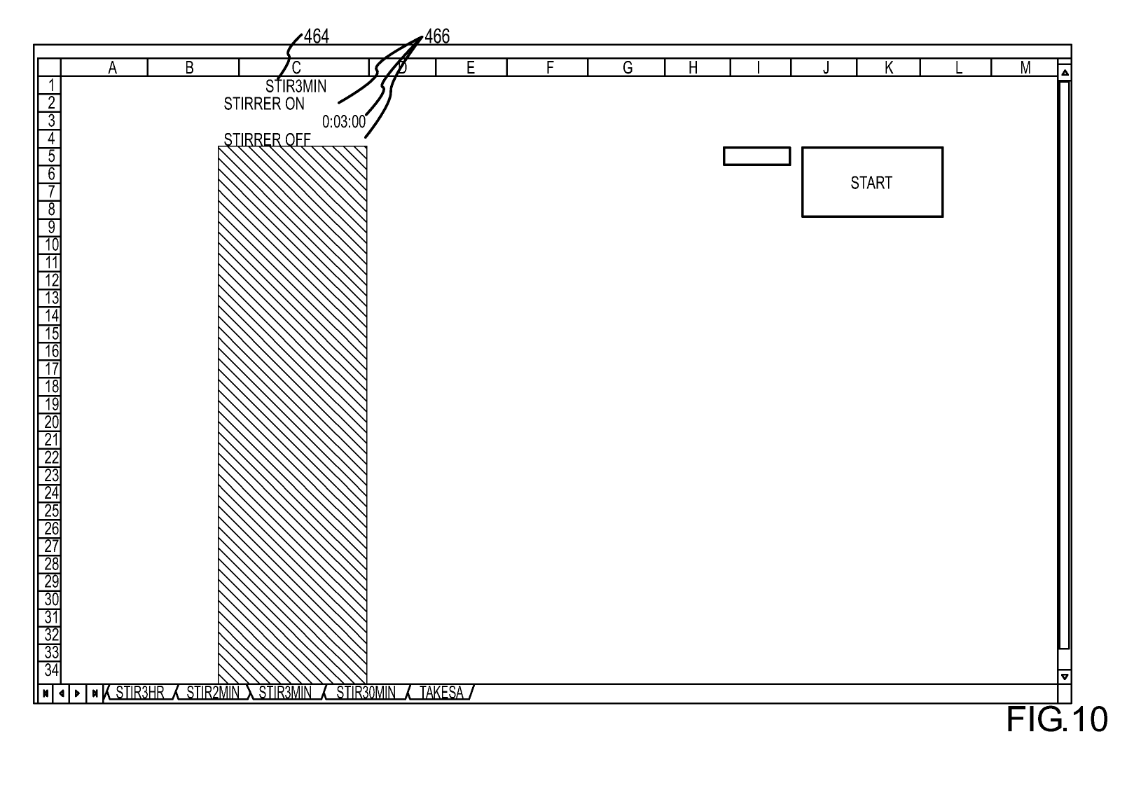

As the command routine 452 is initiated, the first command of the higher level commands 462 is executed, which calls one or more intermediate level commands 464, which in turn may call one or more lower level commands 466, which, as is discussed in further detail below, are translated to electronic signals and communicated to the reaction system 10. For example, in the illustrated embodiment the higher level command 462 “SOAK” references a plurality of intermediate level commands 464 “Precharge DCM SOAK”, “CHARGE”, “STIRRER ON”, etc., each of which may reference lower level commands 466. In the illustrated embodiment, the intermediate level command 464 being referenced is “CHARGE”, which references the lower level commands 466 “PUMP(1,AC1,ON)”, “1:00”, and “PUMP(1,AC1,OFF), which combination of lower level commands corresponds to turning on a certain pump for 1 minute and then turning off that certain pump. Another example of an intermediate level command/lower level command 464/466 relationship is provided in FIG. 9, which illustrates the lower level commands 466 included in a “BLOWDOWN” intermediate level command 464. The “BLOWDOWN” intermediate level command 464 references the lower level commands 466 “PUMP(1,AC3,ON)”, “1:00”, and “PUMP(1,AC3,OFF)”, which combination of lower level commands corresponds to turning on a certain pump for 1 minute and then turning that certain pump off. Yet another example of an intermediate level command/lower level command 464/466 relationship is provided in FIG. 10, which illustrates the lower level commands 466 included in a “STIR3MIN” intermediate level command 464. The “STIR3MIN” intermediate level command references the lower level commands 466 “STIRRER ON”, “3:00”, “STIRRER OFF”, which combination of lower level commands corresponds to turning an agitator (e.g., a stir rod) on for 3 minutes and then turning that agitator off. As shown in FIG. 8, an indicator 467 may be utilized in relation to any of the higher level, intermediate level, and/or lower level commands 462, 464, 466 to indicate that a specific command has been completed.

The command structure provided in the command routine 452 provides a flexible software system that enables the quick and efficient synthesis of nearly infinite organic compounds in an automated fashion. That is, since a higher level command 462 may reference a plurality of intermediate level commands 464, a variety of higher number commands 462 can be efficiently prepared simply by referencing one or more intermediate level commands 464. Moreover, since the intermediate level commands 464 may include a plurality of lower level commands 466 that translate to specific operations of the system, a variety of intermediate level commands 464 can be efficiently prepared simply by referencing one or more lower level commands 466. Thus, a command routine 452 can be prepared by placing a series of higher level commands 462 in a preselected order without requiring the programming of specific parameters for each desired synthesis.

Although the command routine 452 has been described in relation to a higher level, intermediate level and lower level command 462-466 structure, the command routine 452 may include only higher and lower level commands 462, 466. Additionally, the command routine 452 may include any number of levels between the higher level commands 462 and lower level commands 466 in addition to the intermediate level commands 464 to assist in facilitating command routine preparation.

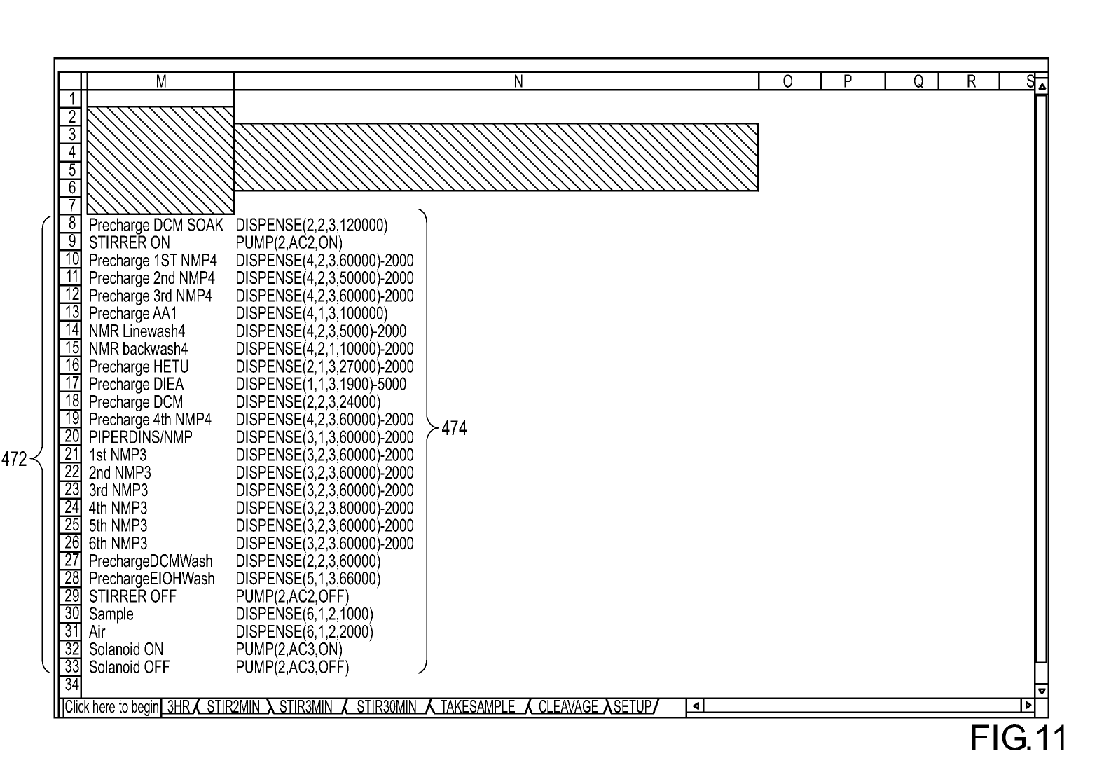

In a further related embodiment, the command routine 452 may further include a set-up page, wherein a user may relate any of the intermediate and/or lower level commands 464, 466 to a specific operation of the reaction system 10. For example, a user can define any operation that can be performed by the reaction system (e.g., open valve) by name and that name can be used by any of the higher level, intermediate level or lower level commands 462-466 to operate the system. One embodiment of an exemplary set-up page is illustrated in FIG. 11, where user-defined names 472 are located in a first column and associated reaction system functions 474 are coded in a second column. Corresponding underlying code (e.g., VISUAL BASIC) may be utilized to correspond such coded functions 474 to the user-defined names 472. Thus, a user can define/assign a reaction system 10 function in a more user-friendly manner to facilitate programming of the command routine 452.

Referring again to FIG. 7, the translation routine 454 may be operable to translate the lower level commands 466 to electronic signals. For example, the translation routine 454 may be operable to translate an “open valve” instruction to a specific electronic signal. The translation routine 454 may communicate this electronic signal to the interface 460, which may communicate the electronic signal to the reaction system 10 via the controller connector cable 410, which may cause the specified valve to be opened. The translation routine 454 may be any known routine adapted to translate instructions from the command routine to electronic signals. For example, the translation routine may comprise WINWEDGE software (Tal Technologies, Inc., Philadelphia, Pa., United States of America).

Referring again to FIG. 6, the interface 460 may be any interface adapted to communicate the signals from the translation routine to electronic signals that are sent to the reaction system 10. For example, the interface 460 may comprise a serial port and an RS-232 interface, which interconnects with one or more controller connector cable(s) 410.

The interface 460 may be communicatively connected to the various portions of the reaction system 10 in serial and/or in parallel. For example, the interface 460 may be communicatively connected to a first pump via the controller interconnection cable(s) 410, and to a second pump via a second cable interconnected to the first pump, wherein a RS-232 protocol is utilized to communicate between the controller and the first pump, and a RS-485 or similar protocol is utilized to communicate between the second pump and the first pump.

The computer 420 may be any computer adapted to process instructions and translate those instructions to signals to control the reaction system 10 (FIG. 1). In one embodiment, the computer 420 is a general use computer adapted to execute the instructions using an operating system (e.g., WINDOWS, APPLE, UNIX, LINUX, etc.). In a related embodiment, at least of a portion of the instructions (e.g., the command routine) is specified within a spreadsheet program (e.g., EXCEL, Microsoft Corp., Redmond, Wash., U.S.A.) and/or database program (e.g., ACCESS, Microsoft Corp., Redmond, Wash., U.S.A.) compatible with the generic operating system of the computer 420.

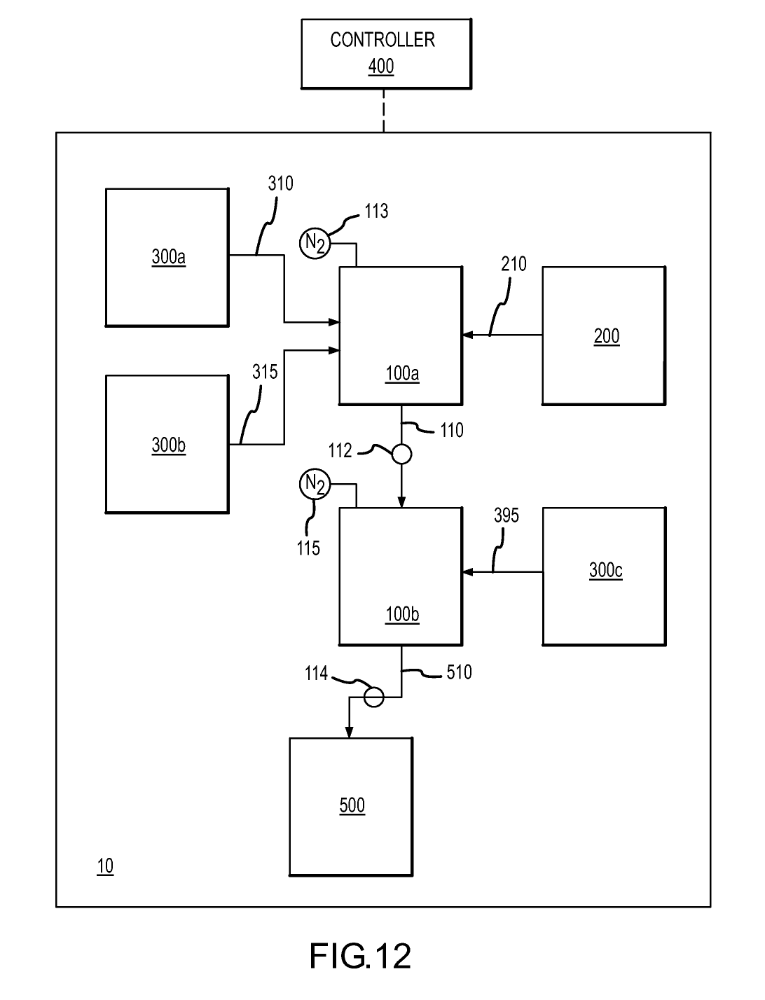

Another exemplary system for synthesizing organic compounds according to the present invention is illustrated in FIG. 12. The system 1000 includes a first reaction unit 100a, which may be fluidly interconnectable to a structural unit chemical dispensing unit 200 via a first fluid interconnection line 210 for receiving structural unit chemicals therefrom. The structural unit chemical dispensing unit 200 may include any of the features described above in relation to the structural unit chemical dispensing unit 200 of FIGS. 3-4. Moreover, although only one structural unit chemical dispensing unit 200 is illustrated, more than one structural unit chemical dispensing unit 200 could be included within the system 1000.

The first reaction unit 100a may further be fluidly interconnectable to a first synthesis chemical dispensing unit 300a via a second fluid interconnection line 310 and to a second synthesis chemical dispensing unit 300b via a third fluid interconnection line 315 for receiving synthesis chemicals therefrom. For example, the first synthesis chemical dispensing unit 300a may be operable to dispense one of a first reagent (e.g., a first coupling agent) and/or a first solvent and/or other synthesis chemicals to the first reaction unit 100a via the second fluid interconnection line 310. The second synthesis chemical dispensing unit 300b may be operable to dispense one of a second reagent (e.g., a second coupling agent) and/or a second solvent and/or other synthesis chemicals to the first reaction unit 100a via the third fluid interconnection line 315.

The first reaction unit 100a may further be fluidly interconnectable to a second reaction unit 100b via a fourth fluid interconnection line 110 and a corresponding valve 112 (e.g., a solenoid valve). When the valve 112 is open, fluids may flow from the first reaction unit 100a to the second reaction unit 100b, and when the valve 112 is closed, fluids are restricted from flowing from the first reaction unit 100a to the second reaction unit 100b. In this regard, a nitrogen (N₂) or other inert gas source 113 may be interconnectable to the reaction unit 100a to assist in effecting fluid transfer between the first reaction unit 100a and second reaction unit 100b. The first and second reaction units 100a, 100b may include any of the features described above in relation to the reaction unit 100 of FIG. 2.

The second reaction unit 100b may also be fluidly interconnectable to a third synthesis chemical dispensing unit 300c, via a fifth fluid interconnection line 395, for receiving synthesis chemicals therefrom. For example, the third synthesis chemical dispensing unit 300c may be operable to dispense one of a third reagent (e.g., a deprotection agent) and/or a third solvent and/or other synthesis chemicals to the second reaction in 100b via the fifth fluid interconnection line 395. The first, second, and third synthesis chemical dispensing units (i.e., units 300a, 300b, and 300c, respectively), may include any of the features described above in relation to the synthesis chemical dispensing unit 300 of FIG. 5. The first, second, third, and fifth fluid interconnection lines (i.e., lines 210, 310, 315, and 395, respectively) may be fluidly isolated from one another so as to facilitate the reduction of possible cross-contamination between the various chemicals contained in the various dispensing units.

As noted, the reaction system 1000 includes two separate reaction units 100a and 100b. Utilizing two different reaction units enables the separation of the coupling reactions from the deprotection reactions, which further assists in reducing the possibility of cross-contamination and/or undesired side reactions with the reaction system 1000. Moreover, utilizing two different reaction units also enables concurrent deprotection of the structural unit chemical (e.g., a peptide in the second reaction unit) and activation of the incoming structural unit chemical (e.g., an amino acid in the first reaction unit), which assists in reducing overall synthesis time and increases production rates.

The second reaction unit 100b may further be fluidly interconnectable to a waste unit 500 via a waste interconnection line 510 and a corresponding valve 114 (e.g., a solenoid valve). When the valve 114 is open, fluids in the second reaction unit 100b may flow to the waste unit 500, and when the valve 114 is closed, fluids in the second reaction unit 100b are restricted from flowing to the waste unit 500. In this regard, a nitrogen (N₂) or other inert gas source 115 may be interconnectable to the second reaction unit 100b to assist in effecting fluid transfer between the second reaction unit 100b and the waste unit 500. The nitrogen sources 113, 115 may be different sources or a single source and may share interconnection lines or have fluidly isolated lines.

One embodiment of operating the exemplary synthesis system of FIG. 12 is now described in reference to peptide synthesis. In this regard, the structural unit chemical dispensing unit 200 of FIG. 12 is referred to as an amino acid dispensing unit. Preliminarily, set-up procedures are completed to ensure that the various fluid interconnection lines 110, 210, 310, 315, 395, 510 are interconnected to the appropriate unit, and that the containers within the amino acid dispensing unit 200 contain the appropriate amino acids and the various synthesis chemical dispensing units 300a-300c contain the appropriate synthesis chemicals. Additionally, valves 112, 114 should be positioned in a closed position and an insoluble support structure should be disposed within the reaction unit 100b.

To begin synthesis, a first amino acid is coupled to the insoluble support structure contained within the second reaction unit 100b. More particularly, a first amino acid may be dispensed from the amino acid dispensing unit 200 to the first reaction unit 100a via the first fluid interconnection line 210. Next, a synthesis chemical comprising a first coupling agent (e.g., NBTU) may be flowed from the first synthesis chemical dispensing unit 300a to the first reaction unit 100a the via second fluid interconnection line 310. In this regard, the first coupling agent assists in activating a terminus of the first amino acid (e.g., either a carboxyl terminus or amine terminus) for bonding to the insoluble support. Subsequently, valve 112 may be opened and the nitrogen source 113 may be activated, and the first amino acid, coupling agent mixture may flow from the first reaction unit 100a to the second reaction unit 100b, which contains the insoluble support structure for supporting the first amino acid. Provided appropriate reaction conditions are present in the second reaction unit 100b, a terminal end of the first amino acid may covalently bond to the insoluble support structure. Any of these procedures can be repeated as necessary.

As the first amino acid is bonding to the insoluble support structure, or afterwards, the valve 112 may be closed, the nitrogen source 113 may be deactivated and the internal lines of the amino acid dispensing unit 200 may be rinsed with a rinsing solution contained within the amino acid dispensing unit 200. More particularly and with reference to FIGS. 3, 4 and 12, the pump valve 244 of the pump 240 may be oriented such that a rinsing solution (e.g., NMP) from a rinsing solution container 250 may be flowed into the barrel of the syringe 242 via rinsing solution interconnection line 245 during retraction of a plunger of the syringe 242. Next, the pump valve 244 may be oriented to allow flow of the rinsing solution in the syringe 242 through the pump valve 244, pump interconnection line 235 and at least partially through the multi-position valve 230 during advancement of the plunger of the syringe 242. Subsequently, the multi-position valve 230 may be moved to a second position to allow flow of a second amino acid through the multi-position valve 230, and the plunger of the syringe 242 may be retracted to return the rinsing solution, and optionally a portion of a second amino acid, into the barrel of the syringe 242. Subsequently, the pump valve 244 may be oriented to another position to enable flow of the chemicals in the barrel out of the syringe 242, through the first interconnection line 210 and into the first reaction unit 100a. Any of these procedures can be repeated as necessary.

While the first amino acid is bonding to the insoluble support or after the bonding is complete, the pump valve 244 may be positioned to allow the rinsing solution from a rinsing solution container 250 to flow into the barrel of the syringe 242 via the rinsing solution interconnection line 245 during retraction of a plunger of the syringe 242. Subsequently, the pump valve 244 may be positioned to allow the rinsing solution in the syringe 242 to dispense through the first interconnection line 210 and to the first reaction unit 100a to rinse/clean such syringe 242, pump valve 244 and/or first fluid interconnection line 210. These procedures assist in cleaning such components of the amino acid dispensing unit 200 and to facilitate the reduction of cross-contamination. Any of these procedures can be repeated as necessary.

While the first amino acid is bonding to the insoluble support or after the bonding is complete and with reference to FIGS. 5 and 12, a synthesis chemical comprising a first solvent (e.g., DCM) of the first synthesis chemical dispensing unit 300a may be flowed through the second fluid interconnection line 310 and to the first reaction unit 100a to rinse such second fluid interconnection line 310 and/or portions of the first reaction unit 100a. Any of these procedures can be repeated as necessary.

After the first amino acid has sufficiently bonded to the insoluble support structure, the controller may: (a) open the valve 112 and activate nitrogen source 113 to flow fluids in the first reaction unit 100a (e.g., solvents utilize to cleanse such first reaction unit 100a) through the fourth interconnection line 110 and into the second reaction unit 100b; and/or (b) direct flow of a synthesis chemical comprising a first solvent from the third synthesis chemical dispensing unit 300b through the fifth fluid interconnection line 395 and to the second reaction unit 100b to rinse such second reaction unit 100b, the first amino acid and/or the insoluble support structure. The valve 114 may be opened at an appropriate time and nitrogen source 115 may be activated to remove chemicals in the second reaction unit 100b to the waste unit 500. Steps (a) and/or (b), noted above, can be repeated as necessary.

Next, a second amino acid from the amino acid dispensing unit 200 may be bonded to the first amino acid. More particularly, valves 112, 114 may be closed, nitrogen sources 113, 115 may be deactivated and a second amino acid from the amino acid dispensing unit 200 may be dispensed to the first reaction unit 100a. Concomitantly, a synthesis chemical comprising a coupling agent may be dispensed to the first reaction unit 100a from either the first synthesis chemical dispensing unit 300a or the second synthesis chemical dispensing unit 300b. The selected coupling agent should be compatible with the amino acid to be bonded, and various coupling agents are more productive with selected amino acids. Thus, the first synthesis chemical disposing unit 300a may include a first coupling agent and the second synthesis chemical dispensing unit 300b may include a second coupling agent. Any of these procedures may be repeated as necessary.

Concomitantly, a synthesis chemical comprising a deprotection agent (e.g., piperdiene) may be dispensed to the second reaction unit 100b from the third synthesis chemical dispensing unit 300c to deprotect the non-bonded terminus of the first amino acid. After the non-bonded terminus has been deprotected, the valve 114 may be opened, the nitrogen source 115 may be activated and the chemicals contained in the second reaction unit 100b may be dispensed to the waste unit 500 via the waste interconnection line 510. After the deprotection agent has been dispensed to waste, the valve 114 may be closed, the nitrogen source 115 may be deactivated and one or more synthesis chemicals (e.g., comprising one or more solvents) may be dispensed to the second reaction unit 100b to rinse/cleanse such reaction unit 100b and prepare the first amino acid for bonding. These synthesis chemicals may later be dispensed to the waste unit 500. Any of these procedures may be repeated as necessary.

Next, valve 114 may be closed, valve 112 may be opened and nitrogen source 113 may be activated. Then, the coupling agent/second amino acid mixture from the first reaction unit 100a may flow to the second reaction unit 100b, when the second amino acid may bond to the unbonded terminus of the first amino acid to form a peptide. After sufficient bonding between the first amino acid and second amino acid has occurred, the valve 114 may be opened, the nitrogen source 115 may be activated and the chemicals contained in the reaction unit 100b, excluding the peptide bonded to the insoluble support, may be dispensed to the waste unit 500 via the waste interconnection line 510. Any of these procedures may be repeated as necessary.

After the second amino acid/coupling agent mixture has been dispensed to waste, the valve 114 may be closed, the nitrogen source 115 may be deactivated and one or more synthesis chemicals (e.g., comprising one or more solvents) may be dispensed to the second reaction unit 100b to cleanse such reaction unit 100b and peptide, after which such synthesis chemicals may also be dispensed to the waste unit 500. Concomitantly, the valve 112 may be closed, the nitrogen source 113 may be deactivated and the amino acid dispensing unit 200 and/or the first synthesis chemical dispensing unit 300a and/or the second synthesis chemical dispensing unit 300b may be cleansed/rinsed, as described above. Subsequently, the valves 112, 114 may be opened, nitrogen sources 113, 115 may be activated and such synthesis chemicals may be dispensed to the waste unit 500 via waste interconnection line 510. Any of these procedures may be repeated as necessary.

The above described procedures may be repeated as necessary to add amino acids to the peptide to create a peptide of a defined sequence (e.g., a polypeptide comprising between 3-50 amino acids, more particularly between 5-25 amino acids, and even more particularly between 7-20 amino acids). When the desired peptide has been synthesized, the peptide may be cleaved from the insoluble support by dispensing a synthesis chemical comprising a cleaving agent (e.g., TFA) to the second reaction unit 100b from the third synthesis chemical dispensing unit 300c via fifth interconnection line 395. The cleaved polypeptide may then be captured. Similar procedures may be utilized in the production of other organic compounds, such as polynucleotides and polysaccharides.

The controller 400 may be used to control one or more of the above-described operations to semi-automate or even fully automate the synthesis system 1. The controller 400 may be used to semi-automate or automate organic compounds synthesis with or without feedback from the reaction system 10. In this regard, due to the high accuracy of the above described syringes, it is not necessary to monitor flow through the reaction system 10, and therefore chemical dispensing operations can be completed without feedback from the reaction system 10. Moreover, timing of the various operations can be estimated, as approximate reaction times are known. Thus, the synthesis system 1 is capable of being automated without feedback from the reaction system 10, although, if desired, feedback may be provided to the controller from appropriate components (e.g., a controllable temperature unit, a sensor and the like).

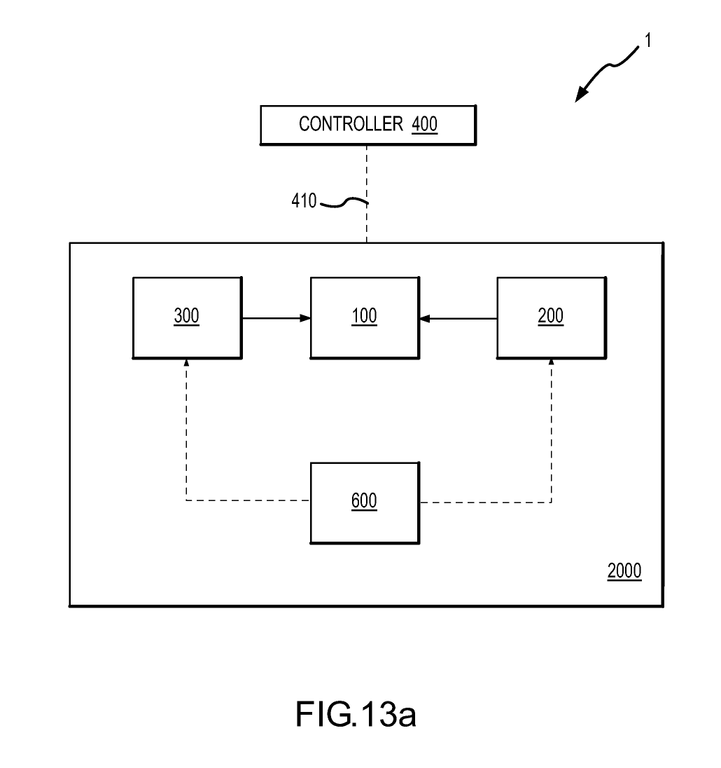

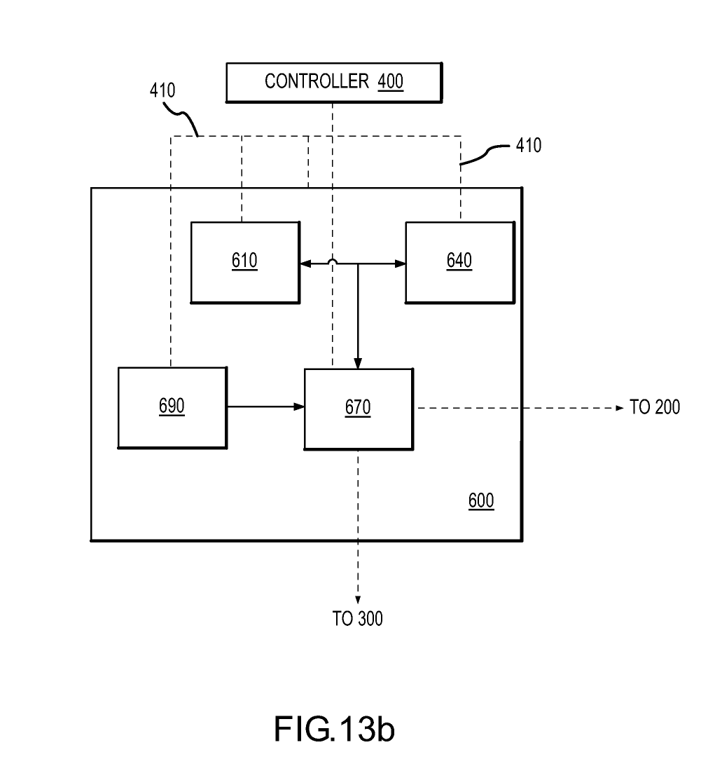

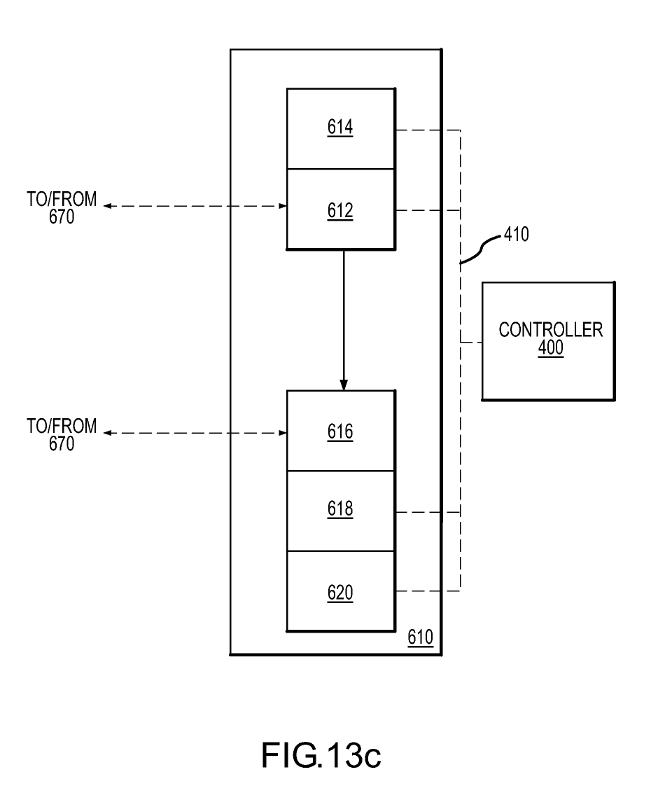

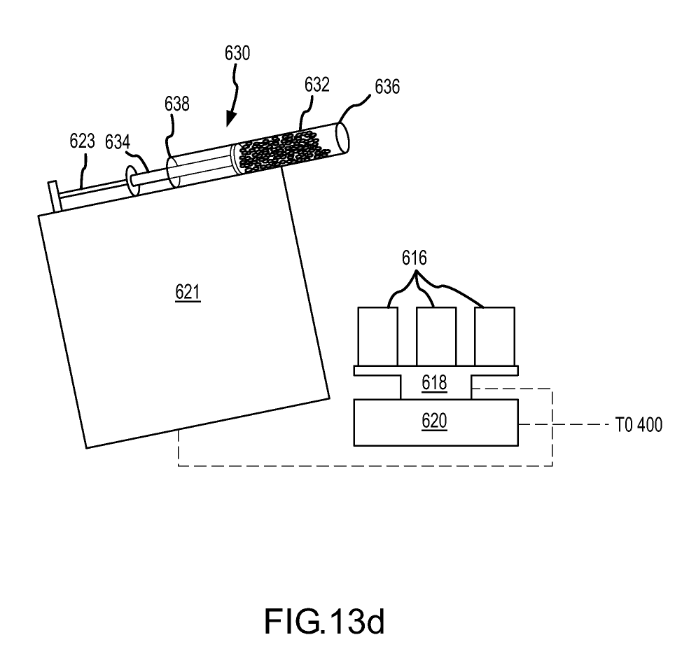

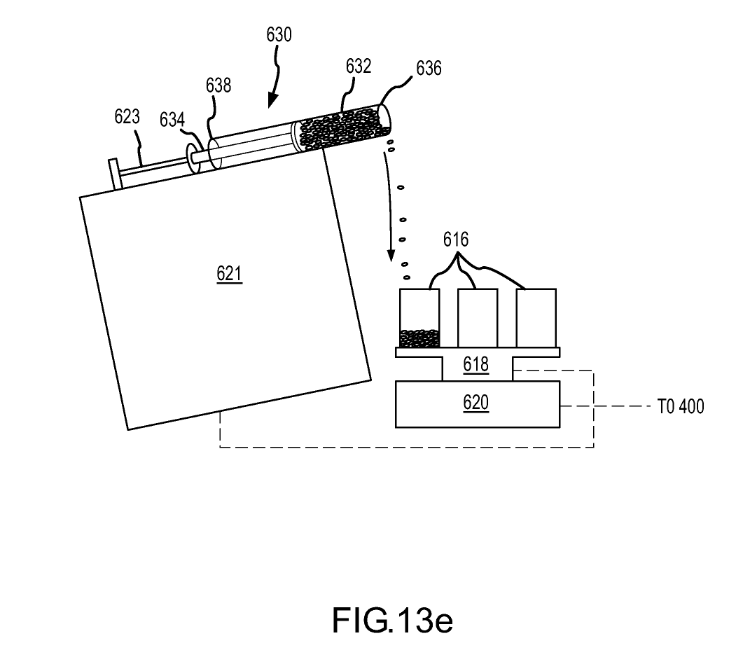

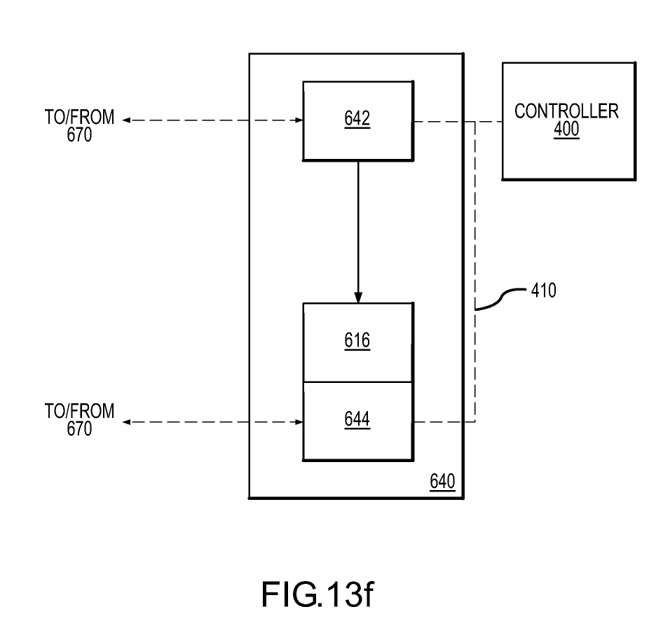

Another embodiment of a reaction system 2000 employable with the synthesis system 1 is now described in relation to FIG. 13a. The reaction system 2000 comprises a structural unit chemical dispensing unit 200, a synthesis chemical dispensing unit 300, and a reaction unit 100, as described above. The reaction system 2000 further comprises a chemical solution synthesis unit 600. The chemical solution synthesis unit 600 may be utilized to synthesize structural unit chemicals and/or synthesis unit chemicals for use by the structural unit chemical dispensing unit 200 and/or the synthesis chemical dispensing unit 300, respectively. In one embodiment, the chemical solution synthesis unit 600 may be automated and operable to deliver containers to one or more of the structural unit chemical dispensing unit 200 and/or the synthesis chemical dispensing unit 300.

One embodiment of the chemical solution synthesis unit 600 is now described in reference to FIG. 13b. The chemical solution synthesis unit 600 may include a first dispensing unit 610, a second dispensing unit 640, a global conveyor 670 and/or a source chemical array 690. The first dispensing unit 610 may be operable to dispense a first chemical to a container (e.g., a solid-phase chemical, such as a pellet), which may be later utilized by one of the structural unit chemical dispensing unit 200 and/or the synthesis chemical dispensing unit 300 (e.g., after being dissolved in and mixed with a solvent). The second dispensing unit 640 may be operable to deliver a second chemical to the container (e.g., a solvent for use with the first chemical to produce a structural unit chemical or a synthesis chemical). The global conveyor 670 may be operable to deliver the container to the structural unit chemical dispensing unit 200 and/or the synthesis chemical dispensing unit 300 for use thereby. The global conveyor 670 may also be operable to deliver a chemical from the source chemical array 690 to one or more of the first and second dispensing units 610, 640. The controller 400 may be communicably interconnected to one or more of the first dispensing unit 610, second dispensing unit 640, the global conveyor 670 and the source chemical array 690 to control such components.

Referring now to FIG. 13c, one embodiment of a first dispensing unit 610 is now described. The first dispensing unit 610 may include one or more of a dispenser 612, an agitator 614, one or more containers 616 (“container(s)”), an in-unit conveyor 618 and a chemical amount measurement device 620 (“measurer”). The dispenser 612 may be any dispenser adapted to dispense a selected amount of chemical to the container(s) 616, such as a dispenser comprising a motorized unit and a syringe, described below.

The dispenser 612 may be communicably interconnectable to the controller 400 to facilitate automation of the first dispensing unit 610. For example, the controller 400 may be operable to send signals to the dispenser 612 to control the direction (e.g., an advancement or retraction direction) and/or speed of operation of the dispenser 612 and/or to stop or start operation of the dispenser 612. In conjunction with the measurer 620, described below, the first dispensing unit 610 may thus be automatable to produce a chemical of a desired amount in the container(s) 616.

The agitator 614 may be utilized to agitate the chemical within the dispenser 612 to facilitate mixing and/or separation of the chemical (e.g. mixing of liquid; separation of solid-phase chemical pellets from one another). The agitator 614 may provide agitation by any know means, including physical and/or electromagnetic means. In a particular embodiment, when solid-phase chemicals are employed in the dispenser 612, the agitator 614 may be operable to provide a one-time or repeating physical impact to the dispenser 612 to facilitate separation of the solid-phase chemical (e.g., separation of agglomerated solid-phase pellets) from one another. The agitator 614 may also be communicably interconnectable to the controller 400 to receive signals therefrom (e.g., start and/or stop agitation operations).

The in-unit conveyor 618 may be any conveyor adapted to move the container(s) 616 into position to be filled by the dispenser. For example, the in-unit conveyor 618 may be a turntable operable to move the containers from a first container position (e.g., in a position to be filled by the dispenser 612) to another position. In a particular embodiment, the in-unit conveyor 618 is robotic. In this regard, the in-unit conveyor 618 may include robotic elements (e.g., servo motors, stepper motors, sensors, switches, articulate arms, grasping devices, hydraulics, etc.), which may be a portion of robotic elements of the global conveyor 670, discussed below, that enable automated operation of the in-unit conveyor 618 and/or the global conveyor 670.

The in-unit conveyor 618 may be communicably interconnectable to the controller 400 to control positioning of the container(s) 616 in relation to the dispenser 612. For example, the in-unit conveyor 618 may be operable to receive signals from the controller 400 corresponding to the positioning of the container(s) 616. The in-unit conveyor 618 may also be operable to send signals to the controller 400 to facilitate control over the positioning of the container(s) 616. For example, the in-unit conveyor 618 may send position coordinate signals to the controller 400 to facilitate positioning of the container(s) 616.

The measurer 620 may be any measurement device adapted to measure an amount of chemical dispensed from the dispenser 612 to the container(s) 616. For example, when solid-phase chemicals are employed in the dispenser 612, the measurer 620 may comprise a tarable electric scale. In one embodiment, the tarable electric scale is communicably interconnectable with the controller 400 and operable to send signals to the controller 400 to facilitate automated operation of the first dispensing unit 610. The controller 400 may be operable to utilize such received signals to calculate an amount of chemical dispensed to facilitate operation of the first dispensing unit 610. The controller 400 may also be operable to send signals to the measurer 620 to reset the measurer 620 (e.g., operable to send a “zero signal” to zero out the tarable scale at the beginning of a dispensing operation).

One embodiment of a dispenser is now described with reference to FIGS. 13d-13e. The dispenser 612 may comprise a motor unit 621 adapted to receive a syringe 630 to dispense a selected amount of a solid-phase chemical to the container(s) 616. The syringe 630 may comprise a barrel 632 having a proximal end 636 and a distal end 638. The syringe 630 may also include a plunger 634 slidably disposed within the barrel 630 and extending from the distal end 638 thereof. In the illustrated embodiment, the proximal end 636 of the barrel 630 is substantially open (e.g., the cross-sectional shape of the barrel) to facilitate dispensing and loading of a solid-phase chemical. In another embodiment, the proximal end 636 of the barrel 630 may comprise a nozzle shaped to correspond with the shape of a solid-phase chemical. The motor unit 621 may include a moveable adapter 623 adapted to interconnect with a portion of the plunger. An agitator 614 (not shown) may be interconnectable to the syringe 630. The in-unit conveyor 618 may comprise a turntable disposed on the measurer 620, and the measurer 620 may comprise a tarable electric scale. The controller 400 may be interconnectable with one or more of the motor unit 621, the in-unit conveyor 618 and the measurer 620.

In operation, a first one or more of the containers 616 may be positioned in a fill position(s) (e.g., via receipt of a signal from the controller 400 and rotation of a turntable a preselected amount) and the measurer 620 may be tared (e.g., via receipt of a signal from the controller 400). The moveable adapter 623 may be advanced (e.g., via the motor unit 621, which may be activated by the controller 400), which may result in advancement of the plunger 634 thereby dispensing chemical from the syringe 630 to one or more of the containers 616. Concurrently, the agitator 614 (not illustrated) may be activated (e.g., via receipt of a signal from the controller 400) to facilitate separation of the chemical (e.g., to facilitate un-agglomeration of dry chemical pellets). As the chemical in the syringe 630 is dispensed into one or more of the containers 616, the measurer 620 may send measurement signals to the controller 400, whereupon attaining a preselected threshold the controller 400 may terminate dispensing of the chemical (e.g., via deactivation of the motor unit 621) and deactivation of the agitator 614 (not illustrated). Subsequently, the in-unit conveyor 618 may position a second one or more of the containers 616 to the fill position(s) (e.g., via receipt of a signal from the controller 400 and rotation of a turntable a preselected amount). These procedures may be repeated as desired to facilitate filling of the containers 616 with a desired chemical.

As noted above, a second dispensing unit 640 may also be provided to facilitate automated synthesis of structural unit chemicals and/or synthesis chemicals. One embodiment of a second dispensing unit 640 is now described in reference to FIG. 13f. The second chemical dispensing unit 640 may include a dispenser 642, one or more of the container(s) 616 and/or an in-unit conveyor 644. The dispenser 642 may be adapted to provide a chemical to the container(s) 616 to facilitate production of structural unit chemicals and/or synthesis chemicals. For example, the dispenser 642 may be operable to deliver selected quantities of fluids to a solid-phase chemical contained in the container(s) 616 to produce a chemical of a desired volume and concentration. In one embodiment, the dispenser 642 is a syringe pump adapted to dispense liquid volumes of from about 25 microliters to about 50 milliliters. In one embodiment, the syringe 642 has a dispensing precision of at least about ±2 microliters for every milliliter dispensed, more preferably of at least about ±1 micoliter for every milliliter dispensed, even more preferably of at least about ±0.5 microliter for every milliliter dispensed, and even more preferably of at least about ±0.1 microliter for every milliliter dispensed. The ability to dispense liquid volumes with such dispensing precision may obviate the need for flow meters or other measurement devices within the second dispensing unit 640.

The in-unit conveyor 644 may be configured similar to the in-unit conveyor 618 of the first dispensing unit 610 (e.g., robotic) and may contain any features described in relation thereto. The in-unit conveyor 644 may be communicably interconnectable to the controller 400 to control positioning of the container(s) 616 in relation to the dispenser 642. For example, the in-unit conveyor 644 may be operable to receive signals from the controller 400 corresponding to the positioning of the container(s) 616. The in-unit conveyor 644 may also be operable to send signals to the controller 400 to facilitate control over the positioning of the container(s) 616. For example, the in-unit conveyor 644 may send position coordinate signals to the controller 400 to facilitate positioning of the container(s) 616.

Referring back to FIG. 13b, the global conveyor 670 may be utilized to convey the containers to and/or from the first and/or second dispensing units 610, 640 and/or the structural unit chemical dispensing unit 200 and/or the synthesis chemical dispensing unit 300, as appropriate. For example, the global conveyor 670 may comprise robotic elements adapted to remove containers from and place containers in the structural unit chemical dispensing unit 200 and/or the synthesis chemical dispensing unit 300. The global conveyor 670 may also be adapted to interface with the in-unit conveyors 618, 644 of the first and second dispensing units 610, 640, respectively, to facilitate placement of and removal of containers thereto and therefrom, respectively.

The global conveyor 670 may also be adapted to supply and remove chemicals from the dispensers 612, 642 of the first and second dispensing units 610, 640, respectively. For example, the global conveyor 670 may be adapted to supply receptacles from the source chemical array 690 to the first and/or second dispenser 612, 642 to facilitate automated production of structural unit chemicals and/or synthesis chemicals. The global conveyor 670 may also be adapted to remove spent receptacles from the first and/or second dispenser 612, 642 to further facilitate automated production of chemicals.

The source chemical array 690 may be any array of receptacles containing chemicals for use in the production of structural unit chemicals and/or synthesis chemicals. Each of the receptacles may contain a different chemical, or some or all of the receptacles may contain the same chemical. In one embodiment, the receptacles are adapted to engage with the first and/or second dispenser 612, 642 to facilitate automated production of structural unit chemicals and/or synthesis chemicals. For example, the first dispenser 612 may comprise a motorized unit 21, as described above, and the receptacles may be syringes adapted for engagement with the motorized unit 21. In a particular embodiment, at least one of the syringes of the source chemical array 690 comprises a predetermined amount of fluid to facilitate production operations. In this regard, the controller 400 may be operable to receive signals from the source chemical array 690 corresponding to which chemical and/or an amount of chemical is contained in each of the receptacles.

As noted above, the controller 400 may be interconnected to the chemical solution synthesis unit 600 to facilitate control thereof. In this regard, the controller 400 may include the above-described higher, lower and/or intermediate level commands, each arranged in a preselected order, and each being associated with operations of the chemical solution synthesis unit (e.g., move a container, operate a pump, etc.). Thus, the controller 400 may be utilized to facilitate automated or semi-automated production of structural unit chemicals and/or synthesis chemicals.

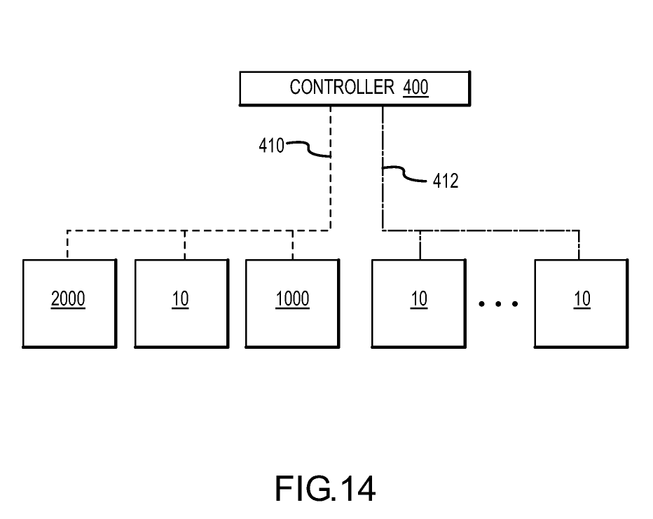

The controller 400 may further be operable to operate one or more reaction systems. For example and with reference to FIG. 14, the controller 400 may be used to semi-automate or automate a plurality of reaction systems 10, 1000 and/or 2000. The controller may be communicatively connected to such plurality of reaction systems 10, 1000 and/or 2000 by one or more interconnections (e.g., via controller connection cables 410 and 412).

The embodiments described above are for exemplary purposes only and are not intended to limit the scope of the present invention. Various adaptations, modifications and extensions of the described system/method will be apparent to those skilled in the art and are intended to be within the scope of the present invention. Moreover, the various numeral references utilized (e.g., first interconnection line, second valve, etc.) are for illustration purposes only and are not meant to imply a number of such components, a required order of use or otherwise.

What is claimed is:

1. A solid phase synthesis system for employing solid phase chemical synthesis techniques to produce organic compounds of a desired structure, the system comprising:
a reaction vessel adapted to receive structural unit chemicals and synthesis chemicals;
a structural unit chemical dispensing unit fluidly interconnectable to said reaction vessel via a first fluid interconnection line;
a synthesis chemical dispensing unit fluidly interconnectable to said reaction vessel via a second fluid interconnection line, said second fluid interconnection line being fluidly isolated from said first fluid interconnection line; and
a controller communicably interconnectable to said structural unit chemical dispensing unit and said synthesis chemical dispensing unit, said controller being operable to send signals to control delivery of structural unit chemicals from said structural unit chemical dispensing unit to said reaction vessel via said first fluid interconnection line and to control delivery of synthesis chemicals from said synthesis chemical dispensing unit to said reaction vessel via said second fluid interconnection line.

2. The system of claim 1, wherein said structural unit chemical dispensing unit comprises:
a plurality of containers, each of said containers being adapted to contain structural unit chemicals;
a multi-position valve comprising a plurality of inlet ports and an outlet port, each of said plurality of inlet ports being fluidly interconnected to a corresponding one of said plurality of containers; and
a pump fluidly interconnectable to said outlet port of said multi-position valve and said first fluid interconnection line.

3. The system of claim 2, wherein said structural unit chemical dispensing unit further comprises:
a controllable thermal unit operable to control a temperature of said structural unit chemicals within said plurality of containers.

4. The system of claim 3, wherein each of said multi-position valve, said pump and said controllable thermal unit is communicably interconnectable to said controller, and wherein said controller is operable to send signals to control each of said multi-position valve, pump and controllable thermal unit.

5. The system of claim 2, wherein said pump comprises a syringe adapted to dispense liquid volumes of from about 25 microliters to about 50 milliliters with a dispensing precision of at least about ±2 microliters for every milliliter dispensed.

6. The system of claim 2, wherein said pump is fluidly interconnectable to a rinsing container, said rinsing container being adapted to contain a rinsing solution.

7. The system of claim 6, wherein said pump is operable to dispense said rinsing solution to said reaction vessel via said first fluid interconnection line.

8. The system of claim 1, wherein said synthesis chemical dispensing unit comprises:
at least one container, said at least one container being adapted to contain a synthesis chemical; and
at least one pump fluidly interconnectable to said at least one container and interconnectable to said second fluid interconnection line, wherein said pump is operable to dispense synthesis chemicals from said at least one container to said reaction vessel through said second fluid interconnection line.

9. The system of claim 8, wherein said at least one pump is communicably interconnectable to said controller and said controller is operable to send signals to control said pump.

10. The system of claim 1, wherein said synthesis chemical dispensing unit is a first synthesis chemical dispensing unit, and wherein said system further comprises:
a second synthesis chemical dispensing unit fluidly interconnectable to said reaction vessel via a third fluid interconnection line fluidly isolated from both of said first and second fluid interconnection lines.

11. The system of claim 10, wherein said first synthesis chemical dispensing unit is operable to dispense a first set of synthesis chemicals to said reaction vessel via said second fluid interconnection line, and wherein said second synthesis chemical dispensing unit is operable to dispense a second set of synthesis chemicals to said reaction vessel via said third fluid interconnection line.

12. The system of claim 11, wherein said first set of synthesis chemicals comprises a first coupling agent and a first solvent, and wherein said second set of synthesis chemicals comprises a second coupling agent and a second solvent.

13. The system of claim 11, wherein said reaction vessel comprises a first reaction vessel, and wherein said system further comprises:
a second reaction vessel fluidly interconnectable to said first reaction vessel via a fourth fluid interconnection line.

14. The system of claim 13, further comprising:
a third synthesis chemical dispensing unit fluidly interconnectable to said second reaction vessel via a fifth fluid interconnection line fluidly isolated from said first, second, and third interconnection lines, wherein said third synthesis chemical dispensing unit is operable to dispense a third set of synthesis chemicals to said second reaction vessel via said fifth fluid interconnection line.

15. The system of claim 14, wherein said controller is communicably interconnectable to said second and third synthesis chemical dispensing units and is operable to send signals to control said second and third synthesis chemical dispensing units.

16. The system of claim 14, wherein said third set of synthesis chemicals comprises a deprotection agent and a third solvent.

17. The system of claim 14, wherein said third set of synthesis chemicals comprises a cleaving agent and a third solvent.

18. The system of claim 1, wherein said structural unit chemicals comprise amino acids.

19. The system of claim 1, wherein said structural unit chemicals comprise nucleotides.

20. The system of claim 1, wherein said structural unit chemicals comprise saccharides.

21. The system of claim 1, further comprising:
a chemical solution synthesis unit comprising:
a dispenser adapted to dispense a selected amount of chemical to a container;
an in-unit conveyor adapted to move said container from a first position to a second position, wherein in said first position, said container may receive said chemical from said dispenser;
wherein said dispenser and said in-unit conveyer are communicably interconnectable to said controller and said controller is operable to send signals to said dispenser and said in-unit conveyor to control said dispenser and said in-unit conveyor.

22. The system of claim 21, wherein said dispenser comprises a syringe and a motorized unit.

23. The system of claim 21, wherein said dispenser is adapted to dispense a selected amount of solid-phase chemical.

24. The system of claim 21, wherein said in-unit conveyor comprises a turntable.

25. The system of claim 21, wherein said in-unit conveyor is robotic.

26. The system of claim 21, further comprising:
a measurer adapted to measure an amount of chemical dispensed from said dispenser to said container.

27. The system of claim 26, wherein said measurer comprises a tarable electric scale.

28. The system of claim 26, further comprising:
an agitator adapted to agitate said chemicals contained in said dispenser.

29. The system of claim 28, wherein said agitator is adapted to physically agitate said chemicals in said dispenser.

30. The system of claim 26, wherein each of said measurer and said agitator is communicably interconnectable to said controller, wherein said controller is operable to send signals to said agitator to control said agitator, and wherein said controller is operable to receive signals from said measurer to calculate an amount of chemical dispensed.

31. The system of claim 21, wherein said dispenser is a first dispenser, said chemical solution synthesis unit further comprising:
a second dispenser;
wherein said first dispenser is adapted to dispense a selected amount of solid-phase chemical into said container, and wherein said second dispenser is adapted to dispense a selected amount of liquid-phase chemical into said container for mixing with said solid-phase chemical to produce one of a structural unit chemical and a synthesis chemical, wherein produced structural unit chemical is employable with said structural unit chemical dispensing unit and produced synthesis chemical is employable with said synthesis chemical dispensing unit.

32. The system of claim 31, wherein said first position corresponds to said first dispenser, said second position corresponds to said second dispenser and said in-unit conveyor is adapted to position said container from said first position to said second position.

33. The system of claim 21, wherein said dispenser is a component of a first dispensing unit, said system further comprising:
a source chemical array comprising a plurality of chemicals, each of said plurality of chemicals being contained in a separate one of a plurality of receptacles.

34. The system of claim 33, wherein said chemicals are employable to produce one of a structural unit chemical and a synthesis chemical.

35. The system of claim 33, wherein said receptacles are adapted for engagement with said dispenser of said first dispensing unit.

36. The system of claim 35, wherein said dispenser comprises a motorized unit and wherein each of said receptacles is a syringe adapted for engagement with said motorized unit.

37. The system of claim 36, wherein said syringe comprises a predetermined amount of one of said plurality of chemicals.

38. The system of claim 31, further comprising:
a conveyor adapted to convey selected ones of said plurality of receptacles from said source chemical array to at least said first dispensing unit, and wherein said conveyor is adapted to remove spent ones of said receptacles from said first dispensing unit.

39. The system of claim 21, wherein said container is one of a plurality of containers, the system further comprising:
a conveyor adapted to convey said plurality of containers to at least one of said structural unit chemical dispensing unit and said synthesis chemical dispensing unit.

40. The system of claim 39, wherein said dispenser is a component of a first dispensing unit, and wherein said conveyor is adapted to convey said plurality of containers from said first dispensing unit to a second dispensing unit, said second dispensing unit comprising a second dispenser.

41. The system of claim 39, wherein said conveyor is communicably interconnectable to said controller, and wherein said controller is operable to send signals to control said conveyor.

42. The system of claim 21, wherein said controller is operable to control said dispenser in parallel with the control of at least one of said structural unit chemical dispensing unit and said synthesis chemical dispensing unit.

43. A method of controlling a solid phase synthesis system having one or more controllable pumps, one or more controllable valves, containers adapted to contain structural unit chemicals and synthesis chemicals, and one or more reaction vessels, said method comprising:
executing a routine, said routine comprising:
a plurality of higher level commands arranged in a preselected order, each said higher level command comprising one or more lower level commands arranged in a preselected order, said lower level commands including instructions corresponding to at least one of activating a pump and positioning a valve;
translating at least said lower level commands to electronic signals; and
directing said electronic signals via an interface to said one or more controllable pumps and one or more controllable valves in order to operate said one or more controllable pumps and said one or more controllable valves in accordance with said routine to direct desired quantities of structural unit chemicals and synthesis chemicals from said containers to a reaction vessel in a desired order.

44. The method of claim 43, wherein said lower level commands include parameters.

45. The method of claim 44, wherein said parameters comprise information identifying a particular pump or valve included in said system.

46. The method of claim 43, wherein said lower level commands further include a delay command associated with delaying the time between execution of prior and subsequent lower level commands.

47. The method of claim 43, wherein each of said higher level commands comprise one or more intermediate level commands arranged in a desired order, wherein one or more of said intermediate level commands comprises one or more of said lower level commands.

48. The method of claim 47, wherein at least one of said intermediate level commands does not include any lower level commands and said at least one intermediate level commands includes instructions corresponding to at least one of activating a pump and positioning a valve.

49. The method of claim 43, wherein said routine executes without feedback from said solid phase synthesis system.

50. The method of claim 43, wherein said routine is executable on a general purpose computer and said interface comprises an RS-232 interface.

51. The method of claim 50, wherein said routine is specified within a spreadsheet program executing on said computer.

52. The method of claim 43, further comprising:
receiving a user-defined name; and
associating said user-defined name with one of said higher-level commands.

53. The method of claim 43, wherein said lower level commands further include instructions corresponding to positioning of a receptacle.

54. The method of claim 53, wherein said lower level commands further include parameters associated with said receptacle.

55. The method of claim 54, wherein said parameters comprise position coordinates.

56. The method of claim 54, wherein said parameters comprise position coordinates of an in-unit conveyor adapted to convey said receptacle from a first position to a second position.

57. A system operable to control a solid phase synthesis system having one or more electronically controllable pumps, one or more electronically controllable valves, containers adapted to contain structural unit chemicals and synthesis chemicals, and one or more reaction vessels, said system comprising:
a command routine comprising a plurality of higher level commands arranged in a preselected order, each of said higher level commands comprising one or more lower level commands arranged in a preselected order, said lower level commands including instructions corresponding to at least one of activating a pump and positioning a valve;
a processor operable to execute said command routine;
a translation routine executable by said processor to translate said lower level commands to electronic signals; and
an interface directing said electronic signals to said one or more controllable pumps and one or more controllable valves in order to operate said one or more controllable pumps and said one or more controllable valves in accordance with said command routine to direct preselected quantities of structural unit chemicals and synthesis chemicals from said containers to a reaction vessel in a preselected order.

58. The system of claim 57, wherein said lower level commands include parameters and wherein said parameters comprise information identifying a particular pump or valve included in said system.

59. The system of claim 57, wherein said lower level commands further include a delay command associated with delaying the time between execution of prior and subsequent lower level commands.

60. The system of claim 57, wherein each of said higher level commands comprise one or more intermediate level commands arranged in a preselected order, wherein one or more of said intermediate level commands comprises one or more of said lower level commands.

61. The system of claim 60, wherein at least one of said intermediate level commands does not include any lower level commands and said at least one intermediate level commands includes instructions corresponding to at least one of activating a pump and positioning a valve.

62. The system of claim 57, wherein said command routine is executable without feedback from said synthesis system.

63. The system of claim 57, further comprising:
a general purpose computer interconnected to said interface, wherein said interface comprises an RS-232 interface, and wherein said command routine is executable on said general purpose computer.

64. The system of claim 63, wherein said command routine is specified within a spreadsheet program executable on said general purpose computer.

65. The system of claim 57, wherein said command routine further comprises:
a set-up page comprising user-defined names; and
reaction system functions corresponding with said user-defined names.

66. A method for automating synthesis of organic chemicals of desired structure, the method comprising:
executing a command to direct a first quantity of a structural unit chemical to a first reaction vessel via a first fluid interconnection line;
executing a command to direct a first quantity of a synthesis chemical to said first reaction vessel via a second fluid interconnection line fluidly isolated from said first fluid interconnection line;
executing a command to direct said first quantity of structural unit chemical and said first quantity of synthesis chemical to a second reaction vessel via a third fluid interconnection line;
executing a command to direct a second quantity of a structural unit chemical to said first reaction vessel via said first fluid interconnection line; and
executing a command to direct a second quantity of a synthesis chemical to said second reaction vessel via a fourth fluid interconnection line fluidly isolated from both said first and second fluid interconnection lines.

67. The method of claim 66, further comprising:
after said executing a command to direct a second quantity of a structural unit chemical to said first reaction vessel step, executing a command to direct a third quantity of synthesis chemical to said first reaction vessel.

68. The method of claim 66, further comprising:
after said executing a command to direct a second quantity of a synthesis chemical to said second reaction vessel step, executing a command to direct said second quantity of synthesis chemical out of said second reaction vessel.

69. The method of claim 66, further comprising:
after said executing a command to direct a second quantity of a structural unit chemical to said first reaction vessel step, executing a command to direct said second quantity of structural unit chemical to said second reaction vessel via said third fluid interconnection line.
